(19) United States
(12) Patent Application Publication
(10) Pub. No.: US 2025/0069050 A1
(43) Pub. Date: Feb. 27, 2025

(54) SYSTEMS AND METHODS FOR AN ELECTRONIC TRANSFER DIRECTORY SERVICE FOR DISTILLATION OR DISTRIBUTION OF FILES

(71) Applicant: The PNC Financial Services Group, Inc., Pittsburgh, PA (US)

(72) Inventors: Beth Marie KLEBACHA, Gibsonia, PA (US); David Richard FRASCONA, Fort Mill, SC (US); Caleb James ABRAHAM, Crafton, PA (US)

(73) Assignee: The PNC Financial Services Group, Inc., Pittsburgh, PA (US)

(21) Appl. No.: 18/948,639

(22) Filed: Nov. 15, 2024

Related U.S. Application Data
(63) Continuation of application No. 18/615,131, filed on Mar. 25, 2024.
Application No. 18/615,131 is a continuation of application No. 18/298,200, filed on Apr. 10, 2023, now abandoned.
(60) Provisional application No. 63/385,765, filed on Dec. 1, 2022.

(51) Int. Cl. G06Q 20/10; G06Q 20/40

(52) U.S. Cl. CPC G06Q 20/10; G06Q 20/4014

(57) ABSTRACT

A method for verifying entities and provide an electronic transfer between entities comprising: retrieving a first reference number and a first transmit number associated with a first entity repository; generating a first internal profile associated with the first entity; generating a first access token; generating a first external profile associated with the first entity; storing the profiles in a directory; retrieving a second identification of a second access token; identifying a second entity associated with the second external profile using the second identification; identifying a second internal profile from the plurality of internal profiles associated with the second entity; using a second reference number and a second transmit number associated with the second internal profile, identifying a current status and a history of a second entity repository associated with the second internal profile; and initiating the electronic transfer from the first entity repository to the second entity repository.

### CROSS-REFERENCE TO RELATED APPLICATION

This application claims the benefit of priority of U.S. Provisional Patent Application No. 63/385,765, filed on Dec. 1, 2022, the entire contents of which are incorporated herein by reference.

### TECHNICAL FIELD

The present disclosure relates to systems and methods providing an electronic transfer directory service for distillation or distribution of files.

### BACKGROUND

Since transactions are often made in real-time and are irrevocable, the need to ensure electronic transfer to the desired individual, service provider, or trading partner is paramount to the success of an entity. Conventional methods and systems allow for entities to make electronic transfers between their repositories, such as file storage locations or repositories for funds, like bank accounts. However, conventional methods and systems for achieving such electronic transfers require sending repository data sufficient to identify and verify the repository. Accordingly, conventional methods and systems perform electronic transfers at a reduced computation efficiency because they require sending such repository data, which is often voluminous. Additionally, when this repository data is transmitted between entities, the transferee must store the data in memory to process the data and identify or verify the transferor entity. Conventional systems and methods that require sending voluminous repository data to achieve electronic transfers thus require a greater memory allocation at the transferee's computer memory.

Entities, like individual users, often have a desire to create convenient directories so that they may store information relating to other entities and entity repositories to which they have made electronic transfers in the past. Conventional systems and methods for performing electronic transfers also present the same efficiency and memory allocation problems when entities want to create these convenient directories. Users may be interested in gathering and generating data on entities to make more complete and useful directories, like contact lists. However, to do this, conventional systems and methods require that entity repository information be transmitted and stored in memory at the computer where it is processed. Accordingly, convenient directories offered by conventional systems create inefficient memory allocation. Similarly, transmitting the entity repository data from where it is stored in the directory to a transferee entity requires transferring voluminous data.

Conventional systems and methods for performing electronic transfers between entity repositories also present security concerns. Conventional methods and systems require transmitting entity repository data to identify and verify the entity repository. If this data falls into the wrong hands, the security of the entity repository, and its contents or funds, for example, may be compromised.

Accordingly, there is a need for easier and more efficient ways to verify entity ownership attributes during electronic transfers, which may include easier ways to perform inquiries from a source system, web service, or digital applications that are more memory and computationally efficient.

### SUMMARY

Embodiments of the present disclosure provide a non-transitory computer readable medium containing instructions that when executed by at least one processor, cause the at least one processor to perform operations for verifying entities and provide an electronic transfer between entities. The processor may retrieve a first reference number and a first transmit number associated with a first entity repository, wherein the first entity repository is owned by a first entity. The processor may generate a first internal profile associated with the first entity, wherein the first internal profile includes the first reference number and the first transmit number associated with the first entity repository. The processor may generate a first access token, wherein the first access token includes a first identification. The processor may generate a first external profile associated with the first entity. The first external profile for the first entity may include the first access token. The processor may store the first internal profile and the first external profile in a directory of profiles. The directory of profiles may include a plurality of internal profiles and a plurality of external profiles, both may be associated with a plurality of entities. The processor may retrieve a second identification of a second access token. The second access token may be associated with a second external profile from the plurality of external profiles. The processor may identify a second entity associated with the second external profile using the second identification. The processor may identify a second internal profile from the plurality of internal profiles associated with the second entity using a second reference number and a second transmit number associated with the second internal profile. The processor may identify a current status and a history of a second entity repository associated with the second internal profile. The current status and the history of the second entity repository may be determined using at least one of a repository owner name, tax identification number, date of birth, address, or phone number. The current status may include at least one of a positive status indication, a neutral status indication, or a negative status indication. The history may include at least one of a positive history indication, a neutral history indication, or a negative history indication. The processor may distribute the current status and the history associated with the second entity repository to the first entity. Upon receiving a positive status indication and a positive history indication, the processor may generate data associated with an electronic transfer from the first entity repository to the second entity repository and provide the data associated with the electronic transfer to the second entity to initiate the electronic transfer from the first entity repository to the second entity repository.

Embodiments of the present disclosure provide a method for verifying entities and providing an electronic transfer between entities. The method may comprise retrieving a first reference number and a first transmit number associated with a first entity repository, wherein the first entity repository is owned by a first entity. The method may further comprise generating a first internal profile associated with the first entity, wherein the first internal profile includes the first reference number and the first transmit number associated with the first entity repository. The method may further comprise generating a first access token. The first access token may include a first identification. The method may further comprise generating a first external profile associated with the first entity. The first external profile for the first entity may include the first access token. The method may further comprise storing the first internal profile and the first external profile in a directory of profiles. The directory of profiles may include a plurality of internal profiles and a plurality of external profiles, both may be associated with a plurality of entities. The method may further comprise retrieving a second identification of a second access token. The second access token may be associated with a second external profile from the plurality of external profiles. The method may further comprise identifying a second entity associated with the second external profile using the second identification. The method may further comprise identifying a second internal profile from the plurality of internal profiles associated with the second entity. The method may further comprise using a second reference number and a second transmit number associated with the second internal profile to identify a current status and a history of a second entity repository associated with the second internal profile. The current status and the history of the second entity repository may be determined using at least one of a repository owner name, tax identification number, date of birth, address, or phone number. The current status may include at least one of a positive status indication, a neutral status indication, or a negative status indication. The history may include at least one of a positive history indication, a neutral history indication, or a negative history indication. The method may further comprise distributing the current status and the history associated with the second entity repository to the first entity. Upon receiving a positive status indication and a positive history indication, the method may further comprise generating data associated with an electronic transfer from the first entity repository to the second entity repository and providing the data associated with the electronic transfer to the second entity to initiate the electronic transfer from the first entity repository to the second entity repository.

Embodiments of the present disclosure provide a system for verifying entities and providing an electronic transfer between entities. The system may comprise at least one processor. The processor may retrieve a first reference number and a first transmit number associated with a first entity repository, wherein the first entity repository is owned by a first entity. The processor may generate a first internal profile associated with the first entity, wherein the first internal profile includes the first reference number and the first transmit number associated with the first entity repository. The processor may generate a first access token, wherein the first access token includes a first identification. The processor may generate a first external profile associated with the first entity. The first external profile for the first entity may include the first access token. The processor may store the first internal profile and the first external profile in a directory of profiles. The directory of profiles may include a plurality of internal profiles and a plurality of external profiles, both may be associated with a plurality of entities. The processor may retrieve a second identification of a second access token. The second access token may be associated with a second external profile from the plurality of external profiles. The processor may identify a second entity associated with the second external profile using the second identification. The processor may identify a second internal profile from the plurality of internal profiles associated with the second entity using a second reference number and a second transmit number associated with the second internal profile. The processor may identify a current status and a history of a second entity repository associated with the second internal profile. The current status and the history of the second entity repository may be determined using at least one of a repository owner name, tax identification number, date of birth, address, or phone number. The current status may include at least one of a positive status indication, a neutral status indication, or a negative status indication. The history may include at least one of a positive history indication, a neutral history indication, or a negative history indication. The processor may distribute the current status and the history associated with the second entity repository to the first entity. Upon receiving a positive status indication and a positive history indication, the processor may generate data associated with an electronic transfer from the first entity repository to the second entity repository and provide the data associated with the electronic transfer to the second entity to initiate the electronic transfer from the first entity repository to the second entity repository.

Embodiments of the present disclosure provide a non-transitory computer readable medium containing instructions that when executed by at least one processor, cause the at least one processor to perform operations for automatic distillation of files of different formats into a uniform format and distribution of the files to destination applications. The processor may receive a plurality of identifications associated with a plurality of source applications. The processor may receive a second identification associated with a destination application. The processor may receive a frequency indication. In response to the frequency indication, the processor may retrieve, using the plurality of identifications, a plurality of files associated with a transaction type from the plurality of source applications. In response to the frequency indication, the processor may transform the plurality of files into one uniform format. The processor may distil the plurality of files into one file in the one uniform format. The processor may distribute, using the second identification, the one file to the destination application.

Embodiments of the present disclosure provide a method for automatically distilling files of different formats into a uniform format and distribution of the files to destination applications. The method may comprise receiving a plurality of identifications associated with a plurality of source applications. The method may further comprise receiving a second identification associated with a destination application. The method may further comprise receiving a frequency indication. In response to the frequency indication, the method may further comprise retrieving, using the plurality of identifications, a plurality of files associated with a transaction type from the plurality of source applications. In response to the frequency indication, the method may further comprise transforming the plurality of files into one uniform format. In response to the frequency indication, the method may further comprise distilling the plurality of files into one file in the one uniform format. In response to the frequency indication, the method may further comprise distributing, using the second identification, the one file to the destination application.

Embodiments of the present disclosure provide a system for automatic distillation of files of different formats into a uniform format and distribution of the files to destination applications. The system may comprise at least one processor. The processor may receive a plurality of identifications associated with a plurality of source applications. The processor may receive a second identification associated with a destination application. The processor may receive a frequency indication. In response to the frequency indication, the processor may retrieve, using the plurality of identifications, a plurality of files associated with a transaction type from the plurality of source applications. In response to the frequency indication, the processor may transform the plurality of files into one uniform format. The processor may distil the plurality of files into one file in the one uniform format. The processor may distribute, using the second identification, the one file to the destination application.

The systems and methods disclosed herein may be used in various applications and business systems. It is to be understood that the foregoing general description and the following detailed description are exemplary and explanatory only and are not restrictive of the disclosed embodiments.

### BRIEF DESCRIPTION OF THE DRAWINGS

The accompanying drawings, which are incorporated in and constitute a part of this specification, illustrate disclosed embodiments and, together with the description, serve to explain the disclosed embodiments.

FIG. 1 illustrates an exemplary application of an electronic transfer directory service, consistent with disclosed embodiments.

FIG. 2 illustrates another exemplary application of the electronic transfer directory service to automatically allow or block electronic transfers between entities based on the repository, consistent with disclosed embodiments.

FIG. 3 illustrates an exemplary schematic for more secure and more efficient electronic transfers using tokens, consistent with disclosed embodiments.

FIG. 4 illustrates an exemplary application of the electronic transfer directory service for automatically scheduling and consolidating electronic files for convenient transfer, consistent with disclosed embodiments.

FIG. 5A illustrates an exemplary electronic transfer directory system, consistent with disclosed embodiments.

FIG. 5B illustrates an exemplary entity computing device, consistent with disclosed embodiments.

FIG. 6 presents a flowchart illustrating an exemplary method for verifying entities and providing electronic transfers between entities, consistent with disclosed embodiments.

FIG. 7 presents a flowchart illustrating an exemplary method for generating a token associated with an external profile and creating a directory entry for that token and external profile, consistent with disclosed embodiments.

FIG. 8A illustrates an exemplary directory of internal profiles and external profiles in memory, consistent with disclosed embodiments.

FIG. 8B illustrates an exemplary custom directory of external profiles, consistent with disclosed embodiments.

FIG. 9 illustrates an example visualization of reporting results that may be displayed on a user device, consistent with disclosed embodiments.

FIG. 10A presents a flowchart illustrating an exemplary method for rearranging icons associated with entities on a graphical user interface based on determined frequencies of electronic transfers associated with each external profile, consistent with disclosed embodiments.

FIG. 10B illustrates an exemplary display on a graphical user interface wherein icons representing entities are automatically rearranged based on the frequency of electronic transfers made between the first entity and the entities associated with the external profiles, consistent with disclosed embodiments.

FIG. 11A presents a flowchart illustrating an exemplary method for automatically rearranging icons associated with entities on a graphical user interface based on updated determined entity repository histories, consistent with disclosed embodiments.

FIG. 11B illustrates an exemplary display on a graphical user interface wherein icons representing entities are automatically rearranged based on updated determined entity repository histories, consistent with disclosed embodiments.

FIG. 12 presents a flowchart illustrating an exemplary method for distilling files of different formats into a uniform format and distribution of the files to destination applications, consistent with disclosed embodiments.

FIG. 13 illustrates an exemplary electronic transfer directory service user application and its associated functions, consistent with disclosed embodiments.

### DETAILED DESCRIPTION

Reference will now be made in detail to exemplary embodiments, discussed with reference to the accompanying drawings. In some instances, the same reference numbers will be used throughout the drawings and the following description to refer to the same or like parts. Unless otherwise stated, technical and/or scientific terms have the meaning commonly understood by one of ordinary skill in the art. The disclosed embodiments are described in sufficient detail to enable those skilled in the art to practice the disclosed embodiments. It is to be understood that other embodiments may be utilized and that changes may be made without departing from the scope of the disclosed embodiments. For example, unless otherwise indicated, method steps disclosed in the figures may be rearranged, combined, or divided without departing from the envisioned embodiments. Similarly, additional steps may be added or steps may be removed without departing from the envisioned embodiments. Thus, the materials, methods, and examples are illustrative only and are not intended to be necessarily limited.

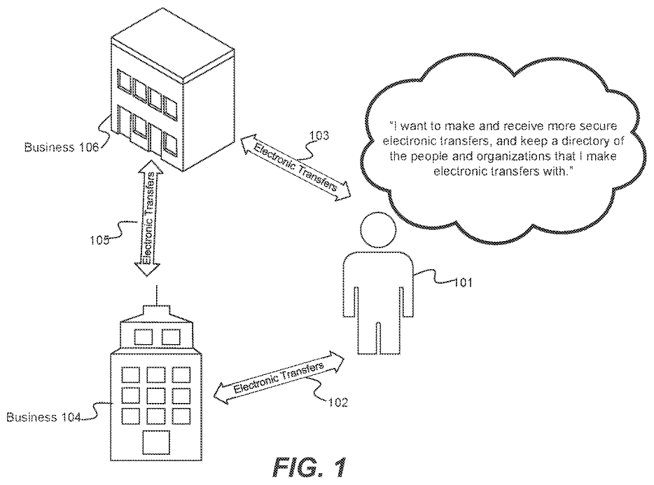

FIG. 1 illustrates an exemplary application of an electronic transfer directory service, consistent with disclosed embodiments. As illustrated in FIG. 1, entity 101, which may be an individual, may want to make electronic transfers 102 or 103 with different entities 104 and 106, which may be businesses. Similarly, for example, business 104 may wish to perform electronic transfer 105 with business 106. Entity 101 and/or businesses 104 and 106 may wish to make and receive more secure electronic transfers 102, 103, and 105, and maintain a directory of the people and organizations that they make electronic transfers with. The systems and methods disclosed in herein may ensure electronic transfers 102, 103, and 105 are performed securely, while also allowing person 101 and businesses 104 and/or 106 to maintain one or more convenient directories. While FIG. 1 illustrates only on person 101 and two businesses 104 and 106, the disclosed systems and methods may be applicable to any number of persons 101, businesses 104 and 106, or any other entities consistent with the present disclosure.

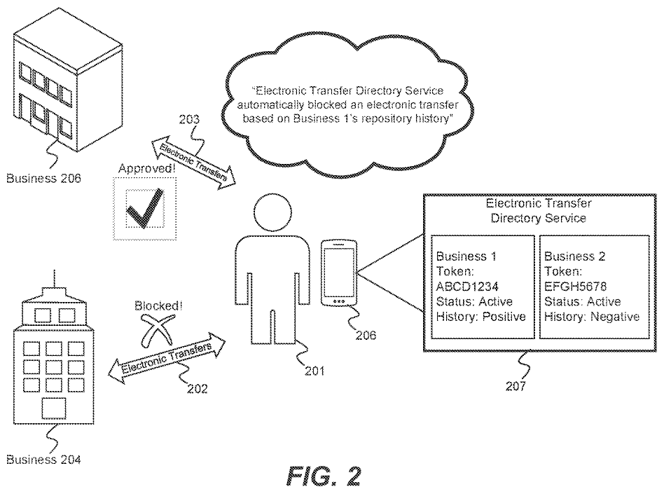

FIG. 2 illustrates another exemplary application of the electronic transfer directory service to automatically allow or block electronic transfers between entities based on the repository, consistent with disclosed embodiments. As shown in FIG. 2, the electronic transfer directory service 207 may display information on the graphical user interface 206 such as a name for each entity, like business 204, an associated token, the status of the business 204's transfer repository, and the history of business 204's transfer repository. The graphical user interface 206 may be realized by a mobile phone, a laptop computer, a desktop computer, or any other comparable device. This information may be automatically reconfigured or rearranged on the graphical user interface 206 based on new updated information received about the entities, such as businesses 204 and 206, or their associated transfer repositories. FIG. 2 further illustrates how the electronic transfer directory service automatically approves an electronic transfer between the entity 201 and a business 204, and automatically blocks an electronic transfer between the entity 201 and business 206. The entity repository achieves this by determining the status and history of the transfer repositories associated with business 204 and business 206 before the transfer is initiated. In some embodiments, the electronic transfer directory service may be integrated into an application, for example, PNC's Pinacle® platform.

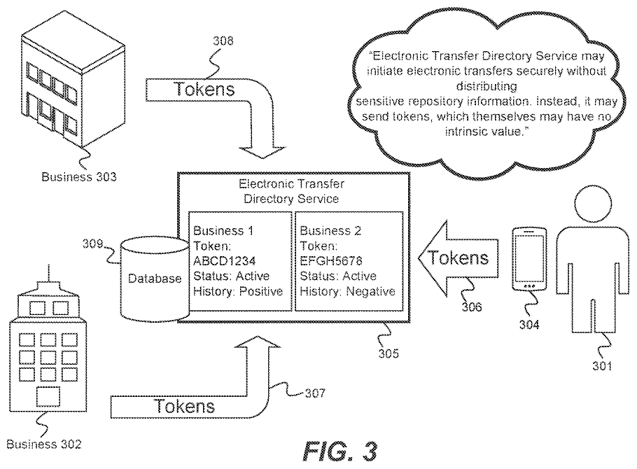

FIG. 3 illustrates an exemplary schematic for more secure and more efficient electronic transfers, consistent with disclosed embodiments. As shown in FIG. 3, the electronic transfer directory service 305 may achieve electronic transfers between entity 301 and/or business 302 and 303, in a more secure and more computationally efficient manner because it may distribute tokens 306, 307, and 308 instead of voluminous sensitive repository and entity information. As shown in FIG. 3, the electronic transfer directory service 305 may be accessed by an entity, which may be an individual, on a mobile device 304. A mobile device 304 may be a mobile phone. The electronic transfer directory service may be stored in a database 309.

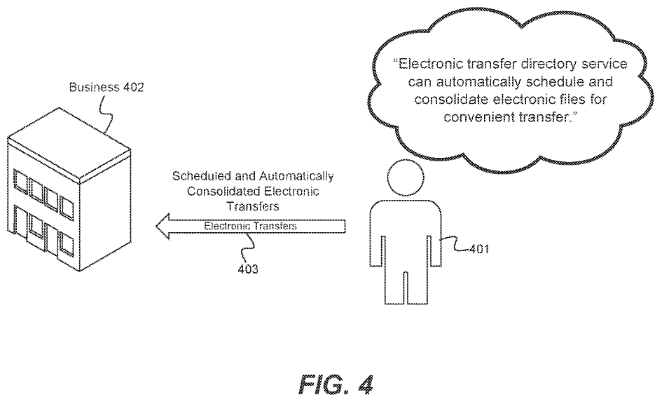

FIG. 4 illustrates an exemplary application of the electronic transfer directory service for automatically scheduling and consolidating electronic files for convenient transfer, consistent with disclosed embodiments. As shown in FIG. 4, in some embodiments the electronic transfer directory service may further automatically consolidate electronic transfers 403, which may be files, into a single convenient format and distribute the electronic transfer 403 files from an entity 401 to a business 402 according to a schedule.

### System, Processor, Memory, Network, and User Interface

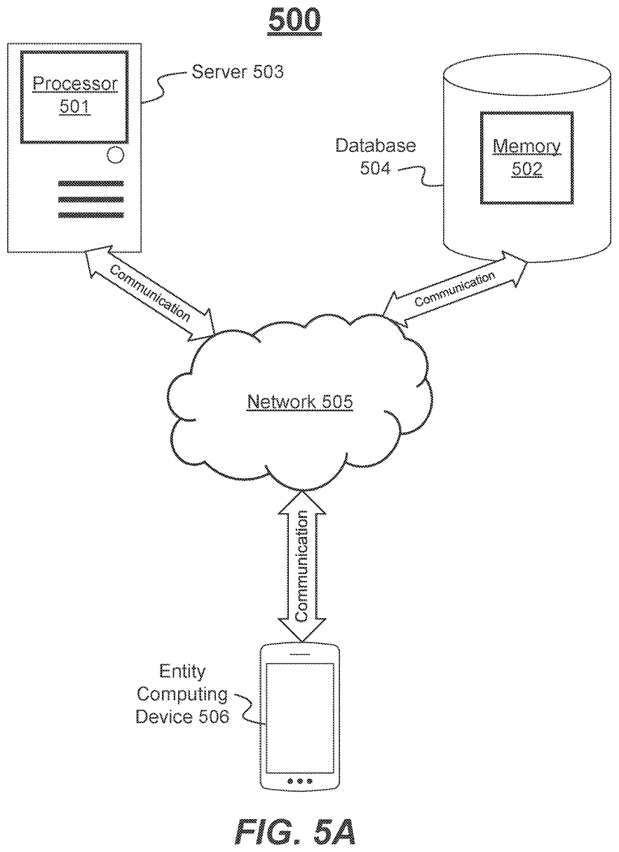

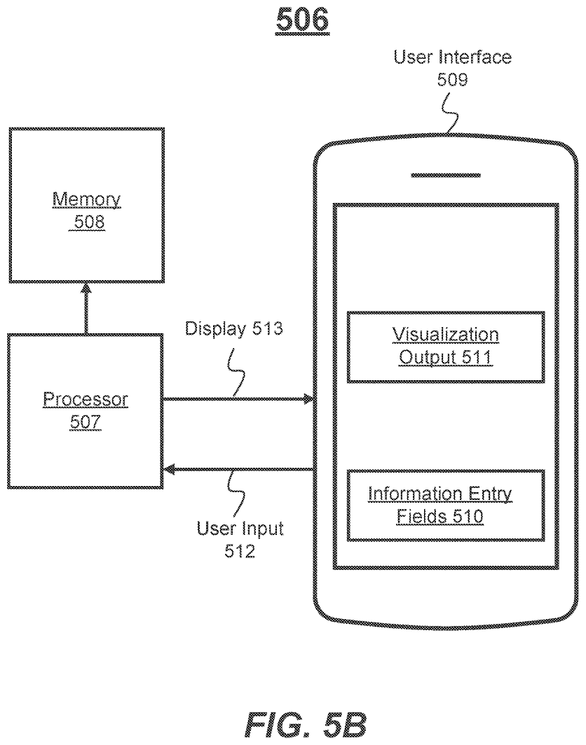

FIG. 5A illustrates an exemplary electronic transfer directory system 500, consistent with disclosed embodiments. As shown in FIG. 5A, system 500 may include a server 503, which may include a processor 501. System 500 may also include a database 504, which may include a memory 502. System 500 may also include a network 505 and may include an entity computing device 506. In system 500, server 503 and database 504 may communicate with each other via network 505, server 503 and entity computing device 506 may communicate with each other over network 505, and entity computing device 506 and database 504 may communicate with each other over network 505.

FIG. 5B illustrates an exemplary entity computing device 506, consistent with disclosed embodiments. As shown in FIG. 5B, entity computing device 506 may include at least one processor, like processor 507, for example. Entity computing device 506 may also include memory 508, and processor 507 may be connected to memory 508. Entity computing device 506 may also include user interface 509, and processor 507 may be connected to user interface 509. User interface 509 may include information entry fields 510 for receiving user input 512. Processor 507 may receive user inputs 512 from user interface 509. These inputs may be, for example, an entity's indication to allow or reject an electronic transfer from another repository, which may involve specifying the token as well as the token type (for example, an access token), in the information entry fields 510. User interface 509 may also contain a visualization output 511. Processor 507 may communicate displays 513 to user interface 509 for display on visualization output 511.

Consistent with disclosed embodiments, “at least one processor” (e.g., 501 or 507) may constitute any physical device or group of devices having electric circuitry that performs a logic operation on an input or inputs. For example, the at least one processor 501 may include one or more integrated circuits (IC), including application-specific integrated circuit (ASIC), microchips, microcontrollers, microprocessors, all or part of a central processing unit (CPU), graphics processing unit (GPU), digital signal processor (DSP), field-programmable gate array (FPGA), server, virtual server, or other circuits suitable for executing instructions or performing logic operations. In some embodiments, the at least one processor (e.g., 501 or 507) may include more than one processor. Each processor (e.g., 501 or 507) may have a similar construction or the processors (e.g., 501 or 507) may be of differing constructions that are electrically connected or disconnected from each other. For example, the processors (e.g., 501 or 507) may be separate circuits or integrated in a single circuit. When more than one processor (e.g., 501 or 507) is used, the processors (e.g., 501 or 507) may be configured to operate independently or collaboratively, and may be co-located or located remotely from each other. The processors (e.g., 501 or 507) may be coupled electrically, magnetically, optically, acoustically, mechanically or by other means that permit them to interact.

The instructions executed by at least one processor (e.g., 501 or 507) may, for example, be pre-loaded into a memory (e.g., 502 or 508), integrated with or embedded into the controller or may be stored in a separate memory. Memory (e.g., 502 or 508) may include a Random Access Memory (RAM), a Read-Only Memory (ROM), a hard disk, an optical disk, a magnetic medium, a flash memory, other permanent, fixed, or volatile memory, or any other mechanism capable of storing instructions. As used herein, a memory (e.g., 502 or 508), refers to any type of physical memory on which information or data readable by at least one processor may be stored. Examples of memory include Random Access Memory (RAM), Read-Only Memory (ROM), volatile memory, nonvolatile memory, hard drives, CD ROMs, DVDs, flash drives, disks, any other optical data storage medium, any physical medium with patterns of holes, markers, or other readable elements, a PROM, an EPROM, a FLASH-EPROM or any other flash memory, NVRAM, a cache, a register, any other memory chip or cartridge, and networked versions of the same.

The terms “memory” (e.g., 502 or 508) and “computer-readable storage medium” may refer to multiple structures, such as a plurality of memories or computer-readable storage mediums located within an input unit or at a remote location. Additionally, one or more computer-readable storage mediums may be utilized in implementing a computer-implemented method. The memory (e.g., 502 or 508) may include one or more separate storage devices collocated or disbursed, capable of storing data structures, instructions, or any other data. The memory (e.g., 502 or 508) may further include a memory portion containing instructions for the processor to execute. The memory (e.g., 502 or 508) may also be used as a working scratch pad for the processors (e.g., 501 or 507) or as a temporary storage. Accordingly, the term computer-readable storage medium should be understood to include tangible items and exclude carrier waves and transient signals.

Some embodiments may involve displaying information on a graphical user interface (e.g., 509), shown in FIG. 5B. A user interface (e.g., 509) may be part of a computing device (e.g., 506) that has inputs and outputs. Accordingly, an entity computing device (e.g., 506) may be a device that has the functionality necessary to realize a user interface 509, for example, a mobile device, desktop, laptop, tablet, or any other devices capable of displaying, receiving, and processing data. Such an entity computing device (e.g., 506) may also include a display such as an LED display, augmented reality (AR), or virtual reality (VR) display.

User interface (e.g., 509) may contain information entry fields 510 for receiving an entity's user input 512. Information entry fields 510 may provide different means for an entity using the user interface 509 to enter information that is eventually received by a processor (e.g., 501 or 507). By way of example, the information entry fields 510 may be a link, a button element, a drop-down menu, or an empty field for the user, or entity, to type in. A user input 512 may be any information the entity using the user interface 509 wants to enter. In some embodiments, this user input 512 may be an entity's indication to allow or reject an electronic transfer from another repository, which may involve specifying the token as well as the token type (for example, an access token), in the information entry field 510. In some embodiments, the user input 512 may be an indication to initiate an electronic transfer or an indication to add another entity to their directory.

User interface 509 may also contain a visualization output 511. Processor 501 or 507 may communicate displays 513 to user interface 509 for display on visualization output 511. A visualization output 511 may be any kind of display screen that may visually display information to an entity. For example, a visualization output may be rendered on a mobile phone screen, a laptop computer screen, or a desktop computer screen. Displays 513 may comprise the data that is displayed on visualization output 511. For example, displays 513 may include a list of icons representing a plurality of entities stored in a first entity's directory that the first entity has engaged in electronic transfers with in the past. Displays 513 may further include information such as graphical display sections that the entity icons are visually arranged into based on determined entity repository histories and statuses. Displays 513 may also include all or some of the data stored in an external profile associated with an entity, which is itself stored in the first entity's directory.

Consistent with the present disclosure, disclosed embodiments may involve a network (e.g., 505). A network (e.g., 505) may constitute any type of physical or wireless computer networking arrangement used to exchange data between, for example, entity computing device 506, server 503, and/or database 504. For example, a network (e.g., 505) may be the Internet, a private data network, a virtual private network using a public network, a Wi-Fi network, a LAN or WAN network, a combination of one or more of the foregoing, and/or other suitable connections that may enable information exchange among various components of the system (e.g., 500). In some embodiments, a network (e.g., 505) may include one or more physical links used to exchange data, such as Ethernet, coaxial cables, twisted pair cables, fiber optics, or any other suitable physical medium for exchanging data. A network (e.g., 505) may also include a public switched telephone network (“PSTN”) and/or a wireless cellular network. A network (e.g., 505) may be a secured network or unsecured network. In other embodiments, one or more components of the system (e.g., 500) may communicate directly through a dedicated communication network. Direct communications may use any suitable technologies, including, for example, BLUETOOTH™, BLUETOOTH LE™ (BLE), Wi-Fi, near field communications (NFC), or other suitable communication methods that provide a medium for exchanging data and/or information between for example, entity computing device 506, server 503, and/or database 504.

Disclosed embodiments may include and/or access a data structure. A data structure consistent with the present disclosure may include any collection of data values and relationships among them. The data may be stored linearly, horizontally, hierarchically, relationally, non-relationally, uni-dimensionally, multidimensionally, operationally, in an ordered manner, in an unordered manner, in an object-oriented manner, in a centralized manner, in a decentralized manner, in a distributed manner, in a custom manner, or in any manner enabling data access. By way of non-limiting examples, data structures may include an array, an associative array, a linked list, a binary tree, a balanced tree, a heap, a stack, a queue, a set, a hash table, a record, a tagged union, ER model, and a graph. For example, a data structure may include an XML database, an RDBMS database, an SQL database or NoSQL alternatives for data storage/search such as, for example, MongoDB, Redis, Couchbase, Datastax Enterprise Graph, Elastic Search, Splunk, Solr, Cassandra, Amazon DynamoDB, Scylla, HBase, and Neo4J. A data structure may be a component of the disclosed system (e.g., 500, a component of memory 502 or 508) or a remote computing component (e.g., a cloud-based data structure). Data in the data structure may be stored in contiguous or non-contiguous memory. Moreover, a data structure, as used herein, does not require information to be co-located. It may be distributed across multiple servers (e.g., 503), for example, that may be owned or operated by the same or different entities. Thus, the term “data structure” as used herein in the singular is inclusive of plural data structures.

Certain embodiments disclosed herein may include a processor (e.g., 501 or 507) configured to perform methods that may include triggering an action in response to an input. The input may be from a user action, for example, a user input 512 in information entry fields 510. A trigger may include an input of a data item that is recognized by at least one processor (e.g., 501 or 507) that brings about another action.

Various embodiments are described herein with reference to a system, method, device, or computer readable medium. It is intended that the disclosure of one is a disclosure of all. For example, it is to be understood that disclosure of a computer readable medium described herein also constitutes a disclosure of methods implemented by the computer readable medium, and systems and devices for implementing those methods, via for example, at least one processor (e.g., 501 or 507). It is to be understood that this form of disclosure is for ease of discussion only, and one or more aspects of one embodiment herein may be combined with one or more aspects of other embodiments herein, within the intended scope of this disclosure.

Embodiments described herein may refer to a non-transitory computer readable medium containing instructions that when executed by at least one processor (e.g., 501 or 507), cause the at least one processor (e.g., 501 or 507) to perform a method. Non-transitory computer readable mediums may be any medium capable of storing data in any memory (e.g., 502 or 508) in a way that may be read by any computing device with a processor (e.g., 501 or 507) to carry out methods or any other instructions stored in the memory (e.g., 502 or 508). The non-transitory computer readable medium may be implemented as hardware, firmware, software, or any combination thereof. Moreover, the software may preferably be implemented as an application program tangibly embodied on a program storage unit or computer readable medium consisting of parts, or of certain devices and/or a combination of devices. The application program may be uploaded to, and executed by, a machine comprising any suitable architecture. Preferably, the machine may be implemented on a computer platform having hardware such as one or more central processing units (“CPUs”) (e.g., 501 or 507), a memory (e.g., 502 or 508), and input/output interfaces (e.g., 509, 510, or 511). The computer platform may also include an operating system and microinstruction code. The various processes and functions described in this disclosure may be either part of the microinstruction code or part of the application program, or any combination thereof, which may be executed by a CPU, whether or not such a computer or processor (e.g., 501 or 507) is explicitly shown. In addition, various other peripheral units may be connected to the computer platform such as an additional data storage unit and a printing unit. Furthermore, a non-transitory computer readable medium may be any computer readable medium except for a transitory propagating signal.

Processor 501, 507 may run computer applications. Applications may be mobile computer programs configured to run on mobile phones or tablet computers. Applications may also be computer programs configured to run on laptop computers or desktop computers. Computer applications are computer software packages designed to carry out specific tasks. Some applications may be front end applications that interact directly with a computer or mobile device user. Processor 507 included in entity computing device 506 may, for example, run front end applications. Back end applications may be applications that support the front end applications and interact with the front end applications. A front end application may call the back end application to process data or to retrieve or access data. Processor 501 included in server 503 may, for example, run back end applications.

Embodiments described herein may refer to methods that include various steps. Unless the order is characterized as necessary, the steps of methods described herein may be performed in any order possible to achieve the results of the method.

### Electronic Transfer Directory Service

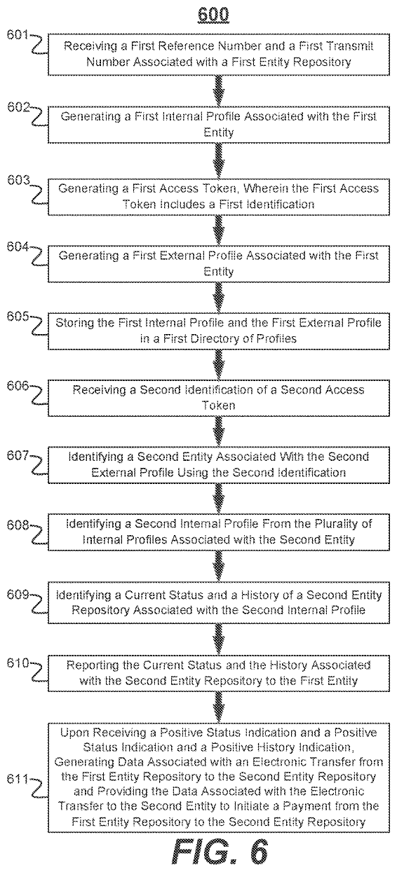

FIG. 6 presents a flowchart illustrating an exemplary method 600 for verifying entities and providing electronic transfers between entities, consistent with disclosed embodiments. Method 600, as shown in FIG. 6, may allow for electronic transfers to be performed in a manner that increases computational and memory efficiency by reducing the amount of data that needs to be transmitted to accomplish the electronic transfer and by reducing the amount of data that needs to be stored in memory. Method 600 may achieve this by transmitting tokens, which may transmit less data and store less data in memory compared to conventional methods.

As shown in FIG. 6, method 600 may include a step 601 of receiving a first reference number and a first transmit number associated with a first entity repository, wherein the first entity repository is owned by a first entity. An entity may be an individual or organization that may be interested in engaging in transactions involving electronic transfers with one or more other individuals or organizations. By way of example, an entity may include a person, a business, non-profit organization, or other similar entities. In some embodiments, the first entity may be a file transferee or a payee. A transferee or payee may be the entity who has electronic files or funds transferred out of their entity repository. By way of example, a transferee may be the entity transferring electronic files out of their entity repository to another entity's repository, similarly, a payee may be the entity transferring electronic funds out of their entity repository into another entity's repository. A first entity repository may be an electronic location where electronic data may be stored. A repository may be referred to as an entity repository when the contents of the repository are owned by the entity. By way of example, a first entity repository may be a location where electronic files owned by the first entity are stored. As another example, an entity repository may be a repository for funds where electronic funds owned by the first entity are stored, like a bank account. A first reference number may include data or information that may be able to identify a repository. For example, a first reference number may be a bank account number which identifies a specific bank account. A first transmit number may be data or information that may be able to identify an institution where the first entity repository exists. For example, if the first entity repository is a repository for electronic funds, then the first entity repository may exist in a bank, and the transmit number may be a routing number identifying the bank. As another example, if a group of electronic files are stored in a first entity repository controlled by a file transfer company, then the transmit number may be a number or other information (e.g., name, description, etc.) that identifies that file transfer company.

In some embodiments, the first reference number and the first transmit number may be received at processor 501, 507. Depending on how system 500 is organized, this may be a processor 507 at an entity computing device 506 or a processor 501 at a server 503, as explained above. In some embodiments, the first reference number and the first transmit number may be received at processor 501, 507 as part of an indication by a first entity that they want to add another entity to their directory, or as part of an indication by a first entity to initiate an electronic transfer to or from another entity. An indication that a first entity wants to add a second entity to their directory may be provided by the first entity interacting with information entry fields 510 in manners consistent with this disclosure. For example, the first entity may push a button on information entry fields 510 which may prompt the first entity to enter information such as typing in the second entity's access token, or other identifying information, as explained further in this disclosure. An indication that the first entity wishes to initiate an electronic transfer to a second entity may be provided in similar manners through interacting with information entry fields 510. In some embodiments, the indication may be that the first entity wishes to initiate an electronic transfer from its entity repository to the second entity's repository. In other embodiments, the indication may be that the first entity requests that they wish for the second entity to initiate an electronic transfer from their entity repository to the first entity's repository.

Method 600 may include a step 602 of generating a first internal profile associated with the first entity, wherein the first internal profile may include the reference number and the transmit number associated with the first entity repository. An internal profile may be a data structure storing information that may be used to identify an entity, a repository associated with the entity, or an institution responsible for maintaining the repository. Internal profiles are called internal because the data may be kept internally without being sent externally or accessed externally by other entities. For example, a first internal profile may be a data structure stored in a memory 502, 508. Processor 501, 507 may be capable of restricting access to this data structure storing the first internal profile so that the first entity and other authorized entities may access it, but other entities cannot. Accordingly, the first internal profile is internal because it contains information that is intended to be internal to the first entity and authorized entities only, and not openly accessible to external entities. Memory 502 may be internal to a database, and memory 508 may be internal to a particular entity computing device 506. In some embodiments, database 504, which may be accessible by server 503, may be managed by an organization that manages entity repositories and database 504 which may store internal profiles. In such embodiments, the organization managing database 504 and server 503 may be a central bank. Accordingly, in some embodiments, the internal profile may be internal to a particular organization, like a bank. The managing organization, may keep the internal profile internally and therefore restrict access to the internal profile by unauthorized entities. As will be explained further in method 600, the managing organization may receive and evaluate tokens as a way to grant access to information stored in the internal profiles. In some embodiments, the internal profile may be stored internally to memory 508, which may be included in entity computing device 506. In these embodiments, the first entity who owns or manages entity computing device 506 may keep the internal profile internal to entity computing device 506 and therefore may use processor 507 to gate keep access to the information stored in the first entity's internal profile in memory 508. Similarly, as explained further in method 600, processor 507 may receive and evaluate a token which may grant permission to access the information stored internally in the first entity's internal profile which may be stored in memory 508.

This information stored in the internal profile may consist of sensitive repository or entity related information, such as a first reference number, a first transmit number, a name, an address, an identifier number (e.g., customer number, username, social security number), telephone number, email address, photograph, fingerprint, voiceprint, or other identifying information. There may be a risk of fraud if this information is intercepted by an unauthorized entity. In some embodiments adapted to fund transfer, the stored information may include the account number and a routing number associated with a bank account.

The processor 501, 507 that receives the first reference number and first transmit number, as described above in this disclosure, may generate the internal profile after being prompted by the first entity to create a new directory entry, which may be associated with its internal profile. This internal profile may also be generated by the processor 501, 507 after being prompted by the first entity to initiate an electronic transfer to a new entity. The internal profile may store the sensitive, more memory consuming, data that identifies a first entity and a first entity repository.

An internal profile may be data stored in a back end. The back end may be server or cloud implemented. For example, database 504, which may include memory 502, may store data like the internal profile. The data in database 504, such as the stored first internal profile, may be accessed by server 503 or a comparable cloud based system. The information stored in the back end may include the reference number and transmit number with an entity repository. The back end may be a single application programming interface (API), and the back end may run on a server 503. The back end may also be cloud based in some embodiments.

As shown in FIG. 6, method 600 may include a step 603 of generating a first access token, wherein the first access token may include a first identification. A first access token may include data that represents an authorization to access resources on behalf of a user. Resources may include sensitive information used to complete an electronic transfer. This sensitive information may be information stored in an entity's internal profile. For example, resources may include data like an entity repository's reference number or transmit number. In other steps that may be included in method 600, sensitive entity information and sensitive entity repository information may be accessed to determine entity repository current statuses and histories, as described in detail below. Access tokens may grant access to resources stored in memory 502, 508 after processor 501, 507 verifies the received access token. Access tokens may be verified through a process called token introspection. Token introspection is described further in the discussion of step 703, which may be included in method 700, below. The actual first access token data may have no intrinsic value on its own and may be limited to only the bare minimum to associate the token with the first identification. For example, a first access token may be string of data that has no essential or exploitable value or meaning. A string of data may be a string of letters or numbers, or some combination thereof.

A first identification may be a string of data that identifies the entity associated with the first access token using only public information. The first identification may provide a convenient way for entities to locate an access token. For example, the first identification may be a name associated with the first access token. The data stored in the first access token itself may not have any intrinsic value, and therefore may not provide any way for an entity to quickly understand to whom the first access token is associated with. By way of example, public information may include information that an entity may provide to other entities, for example, name, address, or phone number. In contrast, information that is not public ordinarily may be sensitive information such as reference numbers and transmit numbers, as defined in this disclosure. Using this easily identifiable information, the first identification may provide a convenient way for entities to search for the first access token, first internal profile, or first external profile, which may be associated in memory 502, 508. The first identification itself may include a short string of data so that it consumes little space in memory 502, 508.

In some embodiments the processor 501 may perform the tokenization of the first internal profile and generate the first access token after the first internal profile is established. Processor 501 may be at server 508, which also may be where the first internal profile is stored in database 509. Step 603 generates an access token so that information may actually be sent externally, either to other devices, processors, or servers over a network, or so that information may be made available for other entities to access in memory 502.

The first access token may be generated by a process called tokenization. Tokenization may be the process of replacing original, sensitive information with non-sensitive placeholder values included in a token. Even if an authorized entity accesses the data making up the token, such as the string of data, the sensitive information the access token is associated with cannot be obtained by reverse engineering.

A first access token may be generated in several ways. For example, first access tokens may be generated using a mathematically reversible cryptographic function with a key. A first access token may also be created using a nonreversible function, such as a hash function. A first access token may also be created using an index function or a randomly generated number. In some embodiments, functions such as OAuth 2 or OAuth 3 client credentials flow may be used by the processor to generate a first access token.

The first access token may be stored in memory 502, 508 after it is generated by processor 501, 507. The first access token may be stored in the same data structure as the first identification and the first internal profile associated with it. The first access token, first identification, and the first internal profile may be associated with each other using means for associating described the present disclosure. For example, the first access token, first identification, and the first internal profile may be associated using a linked list, a look up table, by storing the information in the same database record, or by other similar methods.

A linked list consists of nodes stored in memory 502, 508 where each node contains a data field and a reference to the next node in the list. For example, the first internal profile may be stored in the data field of a node in memory 502, 508, and the node storing the data of the first internal profile may further include a reference to a location in memory 502, 508 storing the first access token. Further, the node storing the data of the first access token may further include a reference to a location in memory 502, 508 storing the first identification. Therefore, the first internal profile, first identification, and the first access token may be associated in the linked list through the memory pointers. A look up table is an array of data in memory 502, 508 that maps input values to output values. Given a set of input values, a look up table may retrieve the corresponding output values from the table. For example, if a look up table mapped an entity identifier input to a first identification, first internal profile, and first access token, then buy inputting the first identification, processor 501, 507 may access and retrieve the first internal profile and the first access token. In this context, the first identification may be like a name in the form of a string of data. As another example, a database record is a collection of information organized in a table that pertains to a specific topic or category. For example, the first identification, first internal profile, and first access token may be stored in the same database record that is organized using entities' identifications. When the first identification is inputted, processor 501, 507 may access the first internal profile, and may also access the first access token stored in the same database record. Other similar means of associating data may be used.

Method 600 may include a step 604 of generating a first external profile associated with the first entity, wherein the first external profile for the first entity includes the first access token. A first external profile may be similar to a first internal profile, as defined above in this disclosure. Except that a first external profile may be a data structure that stores the first access token rather than sensitive repository related information. The first external profile may also be accessible externally by external entities, beyond just the first entity that the first external profile is associated with. By way of example, second entities may have permission to instruct processor 501, 507 to access the first entity's external profile in memory 502, 508. A second entity may have permission to instruct processor 501, 507 to access the first entity's external profile by providing the access token associated with the first entity. An external profile may include information stored on a front-end. A front end may be what is visually accessed or received by any user who wants to interact with the first entity's external profile. For example, a front end may be a software application configured to operate, intake inputs, and display outputs on user interface 509 of entity computing device 506. In some embodiments, the front end may be a mobile application, which may be a type of software application designed to run on a mobile device, such as a smartphone or tablet computer. In other embodiments, the front end may be a software application configured to run on desktop or laptop computers. Information stored on the front-end may mean that the first external profile, and the information it stores, are accessible or transmittable to any user who may want to send electronic transfers to or receive electronic transfers from the first entity. The first external profile may be generated in a similar location to the first access token and the first internal profile, as explained above. This is convenient as the necessary information may be stored in the same memory 502, 508 and therefore accessible by processor 501, 507. For similar reasons to the first access token, the first external profile is generated by processor 501, 507 so that data representing the first entity may be sent externally or accessed in memory 502, 508 by external entities to initiate electronic transfers.

Method 600 may include a step 605 of storing the first internal profile and the first external profile in a first directory of profiles, wherein the first directory of profiles includes a plurality of internal profiles and a plurality of external profiles both associated with a plurality of entities. In some embodiments, a directory may be a data structure stored in memory 502, 508 or in database 504. A database may be database 504, as shown in FIG. 5A, accessible by server 503. A database may be an organized collection of structured information, or data, stored electronically in a computer system. A data structure is defined above in this disclosure. A data structure may be stored in memory 502, 508, which is accessible by processor 501, 507.

In step 605, the plurality of external profiles and the plurality of internal profiles may be associated with a plurality of entities in memory 502, 508 by using a linked list, a look up table, by storing the information in the same database record, or by other similar methods. A linked list may consist of nodes stored in memory 502, 508 where each node contains a data field and a reference to the next node in the list. An external profile or an internal profile may be stored in the data field of a node, and the external profiles and internal profile may be associated in the linked list through the references. A look up table may be an array of data in memory 502, 508 that maps input values to output values. Therefore, given a set of input values, a look up table may retrieve the corresponding output values from the table. For example, a look up table may store matching columns of references to locations memory 502, 508 where external profiles, internal profiles, and entity identifications are stored. By inputting an entity identification into the look up table, the look up table may return data stored at the referenced locations in memory from the look up table column including that inputted entity identification. Accordingly, using a look up table, associated external profiles and internal profiles may all be retrieved, by for example, inputting an entity identification into the look up table. As another example, a database record may be a collection of information organized in a table that pertains to a specific topic or category. Accordingly, storing a plurality of external profiles and a plurality of internal profiles in the same database record may allow for them to all be associated with each other. Other similar means of associating data may be used. These stored associations of external profiles and internal profiles may constitute a first electronic transfer directory.

Method 600 may include a step 606 of receiving a second identification of a second access token, wherein the second access token is associated with a second external profile from the plurality of external profiles. A second access token is similar to a first access token, which was previously discussed in this disclosure. However, a second access token is associated in memory 502, 508 with an external entity, rather than the first entity. The second access token is associated with an entity that the first entity may be interested in making an electronic transfer to or receiving an electronic transfer from. The second identification is similar to the first identification defined above. For example, the second identification may be a string of data associated with the second access token in memory 502, 508.

The second identification may be entered into the application by an entity, for example, through the information entry fields 510, as shown in FIG. 5B. An application may be a mobile application, or an application configured to run on desktop or laptop computers, as explained above in the present disclosure. The way in which an entity or user may interact with information entry fields 510 and therefore input data, such as user input 512, is explained above in this disclosure.

The second access token and second identification may be received by processor 501, 507. There are different ways the second access token may be received by processor 501, 507, depending on which memory the second access token is stored in. In some embodiments, if the second access token is not already stored in memory 502, 508, then the second access token may be received by processor 501, 507 as a data transmission from the second entity to processor 501, 507 over network 505. This data transmission may be a part of a request transmitted by the second entity to the first entity to initiate an electronic transfer. In some embodiments, this data transmission may be a transmission from the second entity to processor 501, 507 made in response to a request made by the first entity to initiate an electronic transfer. In some embodiments, the first entity may be a transferee, payee, transferor, or payor. A transferor is the entity who is engaging in an electronic transfer to transfer electronic files or funds out of the entity repository that they own. A transferee is the entity who is engaging in the electronic transfer to receive electronic files or funds in the entity repository that they own. In some embodiments, the second access token may already be stored in memory 502, 508. If the second access token is already stored in memory 502, 508, then processor 501, 507 may receive the second access token by simply accessing memory 502, 508. The second access token may already be stored in memory 502, 508 if the second entity's external profile is already a directory member of the first entity's electronic transfer directory. Directory members are entity's whose external profiles are stored as entries in an electronic transfer directory, consistent with those described in the present disclosure.

In some embodiments, one or more of the first access token and the second access token may have an expiration time. For example, the expiration time may be one hour, two hours, one day, two days, or some other period of time. An access token's expiration time may also be refreshed and reset before the access token expires. Refreshing an access token may be accomplished through the information entry fields 510 in the user interface 509. In some embodiments, a first and second entity may be in negotiations to further define the exact nature or quantity of electronic files or electronic funds they intend to transfer between each other. In such embodiments, if the first access token or the second access token have expiration times, then either the first entity or second entity may wish to refresh the first access token or the second access token if their negotiations are going to last longer than the expiration times. By way of example, user interface 509 implemented on an entity computing device 506 may have an information entry fields 510 including a button saying, “Refresh Access Token.” By interacting with this button in information entry fields 510, the entity may send a user input 512 to processor 507. Processor 507 may then itself refresh the first access token or the second access token if it is stored in memory 508. Alternatively, if the first access token or second access token is stored in memory 502 in database 504, processor 507 may transmit a command over network 505 to processor 501 instructing processor 501 to refresh the first access token or the second access token in memory 502.

Reference numbers and/or transmit numbers may be tokenized and may be used by directory owners to create new directory members in their electronic transfer directory. Directory owners may be those who own or manage an electronic transfer directory stored in memory 502, 508. Electronic transfer directories may include directory members, where each directory member has an entry in the electronic transfer directory. Directory members may be entities who are associated with at least an external profile and an access token in memory 502, 508 and who have a directory entry created in the electronic transfer directory. When a first entity encounters a new second entity, for example, by completing an electronic transfer with them for the first time, the first entity make create a new entry in their electronic directory storing this second access token, second external profile including information of the new second entity, and second identification. These items may be associated with each other in memory 502, 508 using techniques disclosed herein, and therefore create a new directory member entry in the first entity's electronic transfer directory. In some embodiments directed to fund transfers, account numbers and/or routing numbers may be tokenized and may be used by directory members. When making electronic transfers, access tokens may be transmitted instead of reference numbers. For example, when making electronic fund transfers, in such cases access tokens may be transmitted instead of account numbers.

Method 600 may include a step 607 of identifying a second entity associated with the second external profile using the second identification. A second entity is the entity engaging in the electronic transfer with the first entity. Similar to the first entity, as discussed above in this disclosure, a second entity may be a person, a business, a non-profit organization, or any other similar type of organization. A second entity may be a transferor, payor, transferee, or payee engaging in the electronic transfer with the first entity. A second external profile is similar to the first external profile, as discussed above in this disclosure, except that the second external profile stores data relevant to the second entity.

In some embodiments, step 607 may be accomplished by using the second access token to identify a second external profile, because a token may be associated with the external profile. When decrypted, the second token may yield the second identification, which may be a unique identifier that processor 501, 507 may recognize is associated with the second access token. The second external profile may be associated with a second entity, and accordingly the second entity may be identified using the second external profile. Association may be achieved as previously described in this disclosure. For example, association may be achieved in memory 502, 508 using a linked list, a look up table, by storing the information in the same database record, or by other similar methods. Upon receiving the second access token, processor 501, 507 may query memory 502, 508 for the second access token or for the decrypted second identification. By taking advantage of the associations in memory 502, 508, processor 501, 507 may then identify the relevant external profile and the relevant internal profile in memory 501, 507, as appropriate.

In some embodiments, a second directory of external profiles may be created that includes a list of external profiles associated with a plurality of second entities and second access tokens. A directory may be, for example, like a list of contacts in an application where each contact is a directory entry. A first entity, like a user generally, may want to create a personalized second directory of external profiles associated with second entities so they may conveniently access second entities that they frequently make electronic transfers with. A second directory of external profiles may be created for a user, where the directory contains a list of access tokens associated with entity repositories that the user has previously engaged in an electronic transfer with. In some embodiments, the second directory of external profiles may contain a list of access token associated with bank accounts with which the user has previously performed electronic fund transfers. In some embodiments, the second directory of external profiles may be created for a user where the user adds specific access token associated with accounts chosen by the user. In some embodiments, a directory may be created for a user such that the second directory of external profiles includes external profiles and access tokens for accounts meeting certain criteria, for example, entity repositories, or accounts, in the same line of business as a given entity. In some embodiments, codes for different business types may be stored in an external profile associated with a business. In such embodiments, processor 501, 507 may filter out external profiles based on the business codes to meet the criterion. Other similar criteria may be implemented using similar techniques. Such a second directory of external profiles associated with second entities may be stored in memory 502, 508. Association between second entities' identifications, external profiles, and tokens may be achieved in memory 502, 508 with methods described above in this disclosure. For example, a single directory entry may include a second entity's identification, like a name stored as a string of data, an external profile associated with that second entity's identification, and a second token associated with that second entity's identification.

Method 600 may include a step 608 of identifying a second internal profile from the plurality of internal profiles associated with the second entity. A second internal profile may be similar to the first internal profile, as discussed above in this disclosure, except that it may store data associated with the second entity. A second internal profile may be a data structure that may store information about a second entity. For example, an internal profile may store the second entity's name, address details, or repository reference number and transmit number. In some embodiment, the repository reference number may be a bank account number and the transmit number may be a routing number.

In some embodiments, step 608 may be accomplished by identifying a second internal profile using the second entity that was identified in step 607. This is because an entity may be associated with an internal profile. Association may be achieved using the methods described above in this disclosure. Once the second internal profile is identified, then the reference number and transmit number for the second entity's repository, among other information, may be accessed by the processor 501, 507. By way of example, the second internal profile may be associated in memory 502, 508 with an entity's identification, which may be a name stored as a string of data. When a processor searches in memory for the second entity identification, it may be able to access the second internal profile. The processor 501, 507 that accesses the second internal profile may be a processor that has permission to do so, because internal profiles may be kept private from other entities' access. Processor 501 may perform the necessary operations at the server where the second entity's internal profile is stored. Like a token, the second identification may be small amount of data limited only to what is required to identify the second internal profile and the second entity.

Method 600 may include a step 609 of using a second reference number and a second transmit number associated with the second internal profile, and identifying a current status and a history of a second entity repository associated with the second internal profile. A second reference number and a second transmit number may be similar to the first reference number and the first transmit number discussed above in this disclosure, except that they may relate to a second entity repository. A second entity repository may be similar to the first entity repository, discussed above in this disclosure, except that it may be associated with the second entity. A current status of the second entity repository relates to whether the second entity repository is actively open and being used by a legitimate entity. For example, the current status of the second entity repository may relate to whether the second entity repository has made and received electronic transfers in the past few weeks, or whether the second entity repository is associated with a legitimate, verifiable, second entity. The current status of the second entity repository may also indicate whether the second entity repository is associated with a legitimate current address, or social security number. A history of a second entity repository may indicate the health of the second entity repository and how it is managed. Entities may not wish to engage in electronic transfers with other entity repositories that are poorly managed. For example, the history may indicate whether there is a likelihood that an electronic transfer from the second entity repository is going to be delayed. In some embodiments, the history may indicate that there is a likelihood that the second entity repository is unlikely to hold sufficient contents to fully complete the electronic transfer. For example, in some embodiments directed to electronic transfers of funds, the history may indicate whether the second entity repository is managed in a way that electronic transfers of funds from the second entity repository are often made late, or whether electronic transfers of funds from the second entity repository often include insufficient funds to complete the agreed electronic transfer. The electronic transfer directory service may use these status and history indications to automatically approve or block electronic transfers on behalf of the first entity.

The current status and the history of the second entity repository may be determined using, for example, at least one of an account owner name, tax identification number, social security number, date of birth, address, or phone number. The current status may include one of a positive status indication, a neutral status indication, or a negative status indication. A positive status indication may mean the repository is open and active. A neutral status indication may mean the repository is open and inactive. A negative status indication may mean the repository is closed and inactive.

In some embodiments, the current status indication may include verifying a standing of the second entity repository and an ownership of the second entity repository. Verifying ownership may mean verifying that the entity repository is owned by an entity associated with the internal profile. Standing may mean whether the repository is open and whether the repository is active. In some embodiments, verifying repository ownership and standing may be accomplished with applications such as GIACT. The back end may include computer applications such as GIACT. GIACT may be an end to end, API solution that fully addresses identity, fund transfer, and compliance risk. For example, processor 501, 507 may run GIACT and pass data regarding ownership of the second entity repository to GIACT by calling GIACT's software functions and passing input variables. GIACT may then return a value indicating that the passed ownership data is valid, and may return a value indicating whether the repository is open and active, closed and inactive, or open and inactive.

The history may include at least one of a positive history indication, a neutral history indication, and a negative history indication. A positive history indication may be calculated by assigning weights to the data points contributing to a positive history indication, and then taking a weighted average of the data points. If the weighted average falls above a first predetermined threshold, then a positive history indication may be assigned. For example, the first predetermined threshold may be a number on a scale, above which indicates a positive history for that second entity repository. Data points contributing to a positive history indication may include, but are not limited to, data showing that the repository does not have a history of overdrafting, a history of paying bills on time, paying more than the minimum amount due, a history of allocating money to insurance and investment, a history of avoiding debt, and/or other similar data points or characteristics.

A neutral history indication may be calculated by assigning weights to the data points contributing to a neutral history indication, and then taking a weighted average of the data points. If the weighted average falls within a predetermined range, then a neural history indication may be assigned. The predetermined range may be a range between two numbers on a scale, where a weighted average falling between those two numbers on the scale indicates a neutral history for that second entity repository. In some embodiments, the predetermined range may have an upper bound set as the first predetermined threshold for a positive history indication, and a lower bound set as the second predetermined threshold for a negative history indication. Data points contributing to a neutral history indication may include, but are not limited to, data showing a history of paying only the minimum amount due, that the account has an occasional history of overdrafting, a history of allocating money to only one of insurance or investment, no more than incidents of concerning debt, and other similar data points or habits.

A negative history indication may be calculated by assigning weights to the data points contributing to a negative history indication, and then taking a weighted average of the data points. If the weighted average falls below a second predetermined threshold, then a negative history indication may be assigned. For example, the second predetermined threshold may be a number on a scale, below which indicates a negative history for that second entity repository. Data points contributing to a negative history indication may include, but are not limited to, data showing a history of frequent overdrafting, a history of frequent late payments, a history of allocating no money, or almost no money, to insurance or investment, a history of concerning debt, and other similar data points or habits.

Method 600 may include a step 610 of reporting the current status and the history associated with the second entity repository to the first entity. The current status and the history associated with the second entity repository may include the information determined in step 609. The reporting may be done in different manners depending on where the current status and history are determined. If the current status and history are determined at processor 501 included in server 503, then the determined current status and history may be transmitted by processor 501 to processor 507 at the entity computing device 506, where processor 507 may store the determined current status and history in memory 508. This may allow processor 507 to subsequently access the determined current status and history. Alternatively, if the current status and history are determined at processor 507, then the reporting may consist of processor 507 storing the current status and history in memory 508 where they are accessible to processor 507.

In some embodiments, step 610 may further include issuing a reporting response. A reporting response may be a notification including a wide variety of additional information about the second entity repository or the second entity itself. In some embodiments, the reporting responses may be customized by the first entity to include information they may wish to have reported to them. For example, a front end application running on entity computing device 506 may display on visualization output 511 a number of reporting response options, the first entity may then select their custom reporting responses uses buttons in information entry fields 510 or by typing text in information entry fields 510 specifying the names of reporting responses they wish to receive. A reporting response may include several pieces of information, for example, the date the repository was added, a repository closed date, a repository last updated date, a repository result, repository type, repository name, created date, customer result, fund confirmation result, a reference identification, or a verification result. In some embodiments, the repository may be a repository for funds, such as a bank account.

A repository result, which may be reported as part of the information in step 610, may be an account result in some embodiments. An account result may include an account code, an account description describing whether the account was verified (for example. “the account was found to be an open and valid checking account”), and an account status code. A customer result may include an account code, may include a description of whether the account is verified (for example, “the account was found to be an open and valid checking account”), and may include an account status code. A fund confirmation result may include an account code, a description describing whether the account was verified (for example, “the account was found to be an open and valid checking account”), and an account status code. A verification result may include an account code, a description describing whether the account was verified (for example, “the account was found to be an open and valid checking account”), and an account status code.

In some embodiments, repository codes may be account status codes referring to a repository for funds, such as a bank account. Possible account status codes may be reported as part of the information reported in step 610 when certain events occur. Possible account status codes may include an indication that the response will include a verification result, an account result, or a customer result. Other possible account status codes may include a bad request code (for example, “malformed syntax” or “invalid formatting”), an unauthorized code (for example, “API request did not come with the proper credentials to authorize its use”), a forbidden code (for example, a request is formed correctly, but that the user does not have permission for the resource), a not found code (for example, “the API cannot map the client's URI to a resource”), a method not allowed code (for example, there is an incorrect HTTP method, such as POST instead of GET), an unsupported media type code (for example, “invalid type,” such as XML instead of JSON), response data for error responses (for example, the reason for the error), or an error connecting to the server code.

Possible verification results may be reported in step 610 when certain events occur. Possible verification results may include an error code (for example, “there was an error with the inquiry, check the error message property for details”), a private bad check list code (for example, “the bank account in the inquiry was found on the API user's private bad check list”), a declined code (for example, “the suggested action is to decline the bank account and/or customer data for this inquiry”), a rejected item code (for example, “the suggested action is to not accept an item with the check number on this inquiry”), an accept with risk code (for example, “the suggested action is to further investigate or accept the bank account and/or customer data for this inquiry with known risk”), a risk alert code (for example, “the suggested action is to further investigate the bank account and/or customer data for this inquiry due to a risk alert”), a pass code (for example, “the suggested action is to accept the bank account and/or customer data for this inquiry”), a pass NDD code (for example, “the bank account in the inquiry is a Non-Demand Deposit account”), a negative data code (for example, “there was negative data found associated with the account”), a no data code (for example, “no data was found for the bank account and/or customer data”).

In some embodiments, repository results may be account results that may refer to a repository for funds, such as a bank account. Possible account results may include a negative data code (for example, “negative information was found in an account's history”), a reject item code (for example, “the routing number is reported as not currently assigned to a financial institution,” or that “this item should be rejected based on the risk factor being reported”), a private bad check list code (for example, “the account was found active in your private bad checks list”), a declined code (for example, the “routing number,” “account number.” “check number,” or “amount” “number supplied fails the validation test,” or that “the routing number is from a participating bank but the account number is not located,” or that “this item should be declined based on the risk factor being reported”), a no data code (for example, “no positive or negative information has been reported on the account,” or that “the routing number can only be valid for US Government financial institutions”), an accept with risk code (for example, “current negative data or recent negative data exists on the account”), a pass NDD code (for example, “Non-Demand Deposit Account (post no debits),” “Credit Card Check,” “Line of Credit,” “Home Equity,” “Brokerage Check,” or other type of non-demand deposit account), or a pass code (for example, “the account is verified an found to be an open and valid checking account,” “this account was found to be an American Express Travelers Cheque account,” “this account was reported with acceptable positive data found in current or recent transactions,” “the account was found to be an open and valid savings account,” “the checking account was found to have a positive history,” or “the savings account was found to have a positive history”).

In some embodiments, the entity may be recipient of an electronic transfer, and this may be a customer. Possible customer results may include a declined code (for example, “declined Information submitted failed authentication check, or the information submitted failed identification checks”), a pass code (for example, “customer authentication passed Authentication check,” “customer identification passed identification,” or that “multiple secondary data points did not match identification data”), a risk alert code (for example, “the customer name, business name data, tax information (SSN/TIN/EIN) data did not match authentication data or identification data,” or that “multiple secondary data points did not match authentication data”), an accept with risk code (for example, the customer's address, phone data, or date of birth or identification data “did not match authentication data or identification data”).

In some embodiments, the reporting may be provided to the first entity using a user interface. As shown in FIG. 5, processor 501, 507 may send the reporting information as display 513 to user interface 509. The reporting information then may be displayed on visualization output 511. For example, in one exemplary embodiment, the visualization output 511, included in user interface 509, may display a variety of output information to the user, including account added, closed, and last updated date, the account code, the result of the account verification, account status, bank account type and name, and an account reference identifier (any identifier is hereafter referred as “ID”). Visualization output 511 may display multiple items of information, which may include the received account result, status codes, verification results, account results, or customer results.

As shown in FIG. 6, method 600 may include a step 611 of, upon receiving a positive status indication and a positive history indication, generating data associated with an electronic transfer from the first entity repository to the second entity repository and providing the data associated with the electronic transfer to the second entity to initiate an electronic transfer from the first entity repository to the second entity repository. A positive status indication and a positive history indication are defined above as items that may be determined at step 609. Data associated with the electronic transfer includes any additional data is the necessary to carry out the transaction according to the wishes of the first entity and the second entity. For example, the data associated with the electronic transfer may include the type of electronic transfer, which may be different in the several embodiments disclosed below, or the amount of the electronic transfer. Data associated with the electronic transfer may also include any instructions or narratives attached to the electronic transfer. The data associated with the electronic transfer may additionally result in an output consisting of a display 513 being sent to user interface 509 as shown in FIG. 5B. The output display 513 may be displayed on visualization output 511.

In some embodiments, the electronic transfer of funds may be a Real Time Payment (RTP). RTP is a network that allows for instant electronic transfer of funds, like payments, allowing financial institutions to provide a better, more efficient service to their customers. The network allows eligible institutions to send and receive payments any time of day, which allows businesses speed, convenience and better cash flow control. Using RTPs may help optimize computer performance by minimizing payment inquires, thus, payees may dedicate fewer resources to receivables posting and reconciliation.

In some embodiments, the electronic fund transfer, which may be a payment, may be a wire payment (or WIRE) between entity repositories for funds, which may be bank accounts. A wire payment, or wire transfer, may be an electronic transfer of funds via a network that is administered by banks and transfer service agencies. Wire transfers may allow money to be moved quickly and securely without the need to exchange cash. Wire transfers may allow two parties to transfer funds safely, even if they are in different geographic regions. A wire transfer may be initiated from one bank or financial institution to another. Rather than cash, the participating institutions in a wire transfer may share information about the recipient, the bank receiving account number, and the amount transferred.

In some embodiments, the electronic transfer, which may be an electronic fund transfer like a payment, may be an automated clearing house (ACH) payment. An automated clearing house transaction is an electronic transaction that requires a debit from an originating bank and a credit to a receiving bank. Transactions go through a clearinghouse that batches and sends them out to the recipient's bank.

In some embodiments, the electronic transfer, which may be an electronic transfer of funds like a payment, may be an internal revenue service payment. An internal revenue service payment may be a service used to pay taxes directly from a checking or savings account.

In some embodiments, step 611 may not occur upon a determination that a repository that a first entity, or user, intends to make an electronic transfer to, which may be an electronic transfer of funds, is not in good standing. In such instances, an electronic transfer may be automatically blocked or rejected by the electronic transfer directory service. Good standing may mean that the repository has both a positive status indication and a positive history indication. Neutral standing may mean the repository has at least one of a neutral status indication or a neutral history indication, unless the repository has either of a negative status indication or negative history indication. And a negative standing may mean the repository has at least one of a negative status indication or a negative history indication.

However, not all electronic transfers need to be made between entities that are in good standing. Accordingly, some embodiments, electronic transfers may be made between entities that are not in good standing. In some embodiments, the first entity, or user, may override the blocking or rejection and proceed with the electronic transfer if desired. The overriding may be done through the information entry fields 510 in user interface 509 by specifying the second access token associated with the blocked or potentially blocked second entity. Specifying the second access token may be accomplished in a number of ways. For example, in some embodiments, the first entity may want to specify that processor 501, 507 should never automatically block electronic transfers made with a certain second entity. The first entity may do this by locating that specific second entity's external profile in the first entity's custom directory in memory 502, 508, which may be used to locate the second entity's access token associated with the second entity's external profile in memory 502, 508. The first entity may then select an option in information entry fields 510 that electronic transfers using this second access token are not to be blocked. This selection may be stored in memory 502, 508 in the second entity's external profile. In other embodiments, the first entity may wish to override a blocked electronic transfer just that one time. In these embodiments, user interface 509 may present an option which may include a button in information entry fields 510, asking the first entity if they wish to override the current blocked electronic transfer. In these embodiments, the electronic transfer will go through even step 611 may automatically block the electronic transfer.

Method 600 may improve computer performance speed because processor 501, 507 as shown in FIGS. 5A and 5B, need not transmit as much data as is required in electronic transfers currently known in the art. As described above, to coordinate and initiate the electronic transfer, the electronic transfer directory may transmit an access token. As described above, an access token may comprise information that has no intrinsic value. But access tokens may also comprise less data that the sensitive repository and entity related information that is transmitted in conventional systems and methods. Computer performance speed may relate to how much data processor 501, 507 is required to transmit. Step 607 may allow for processor 501, 507 to use transmitted access tokens to identify second entity internal profiles rather than requiring the voluminous sensitive repository and entity related data used in conventional systems and methods. Therefore, method 600 may improve computer performance speed by allowing processor 501, 507 to transmit and receive tokens rather than raw entity repository, or account, information.

For example, step 607 of method 600 may allow for a second internal profile associated with a second entity to be identified using a second identification derived from a second access token. Conventional methods may require receiving and transmitting large amounts of data related to sensitive entity repository information (for example, reference numbers, account numbers, transmit numbers, routing numbers, billing addresses, the transferor's full name, the payor's full name, or in the context of fund transfers, credit card number, security code, or card expiration date, remittance information, remittance acceptance time, settlement date, confidentiality flags, transaction description, settlement date indication, clearing type, intermediary banks, channel, purpose of transfer, transfer type code. FX quote ID (FX quote may be used to determine the value of a base currency in relation to another currency)). Remittance may refer to a finalized exchange of funds.

Furthermore, transmitting the second access token allows the receiving processor 501, 507 to determine the status and history of an entity repository locally without externally transmitting the data needed to determine the statuses and histories. Instead, after the entity repository statuses and histories are determined, the processor 501, 507 that performed the determinations only needs to externally transmit the determined end results, as in, the determined repository statues and histories. The determined statues and histories may comprise less data than the input data required to make the determinations. The data required to determine entity repository statuses and histories may be consistent with that described in step 609 of method 600. Accordingly, method 600, and specifically step 609, may improve computer efficiency by reducing the amount of data that needs to be transferred to achieve electronic transfers. Along similar lines, some embodiments may allow for an electronic transfer to be processed without the first entity having access to native account data of the other second entity. Native account data may include account numbers or routing numbers in a native data format. A native data format is the file structure of an electronic document as defined by the application that created that electronic document. For example, if a spreadsheet was created using Excel; then that document's native format is its original Excel format. Instead, the electronic transfer directory service may allow for electronic transfers to be processed using tokens as disclosed herein, which may comprise less data than the native account data. Therefore, not transmitting native account data leads to improved computational efficiency by accomplishing electronic transfers with less data transmission.

Furthermore, method 600 may improve computer performance by conserving computer memory in memory 502, 508 shown in FIGS. 5A and 5B. Method 600 may allow for an access token to be saved in memory 502, 508 instead of saving entity repository information data in its raw initial form. Storing access tokens may require less memory, and therefore, storing access tokens rather than raw entity repository information may conserve memory in memory 502, 508. The directory may allow for minimal memory usage because only the access token and associated entity identifier (ID) need to be stored by the directory members, rather than storing voluminous data associated with an entity. As previously described, an access token may be a very small piece of data, like a single string of data. Beyond conserving memory, method 600 may also improve computer performance speed with reference to memory 502, 508 because processor 501, 507 need not access multiple data structures. Instead, a token generated in step 603 and a token received in step 606 may be stored in a single data structure. Therefore, using step 606, processor 501, 507 may only need to access a single data structure. Accessing data structures may involve accessing buffers in memory 502, 508. Computer performance speed may decrease with increasing the number of buffers that processor 501, 507 needs to access in memory 502, 508. By requiring processor 501, 507 to access a single data structure instead of multiple data structures (and thereby reducing the number of buffers that processor 501, 507 must access), method 600, and more specifically step 606, may improve computer performance speed. In some embodiments, the instruction of method 600 may be stored as an individual application programming interface (“API”) or a software developer kit (“SDK”). An API allows software to interact with other software. With an API, tools and other items may be selected individually, each item may be organized one at a time, and it provides for customization of containers for unique tools. An SDK may be a set of software tools that enable a developer to integrate features into software, APIs may be part of the toolkit. An SDK may be a prepackaged solution, ready to use with no customization, and SDK may allow for a short timeline to production.

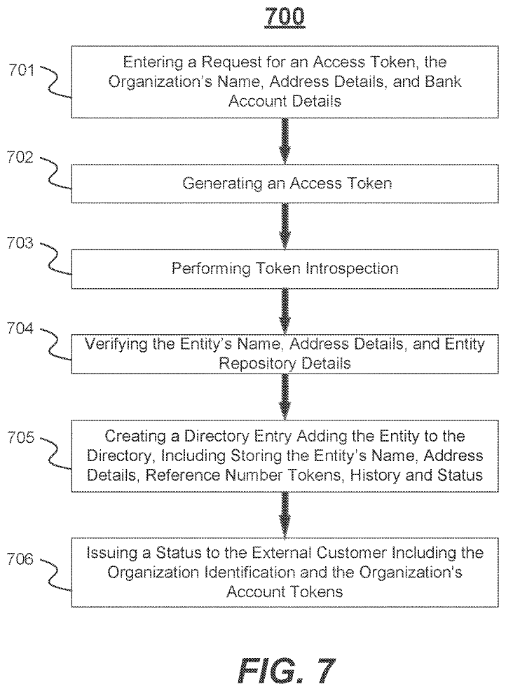

FIG. 7 presents a flowchart illustrating an exemplary method for generating a token associated with an external profile and creating a directory entry for that token and external profile in a custom directory, consistent with disclosed embodiments. There are multiple use cases where method 700, as shown in FIG. 7, may be used. Method 700 may be used as a part of initiating an electronic transfer between a first entity and a second entity where the first and second entity do not already have tokens associated with each other. In some embodiments, method 700 may be used by a first entity who wants to add a second entity to their directory of external profiles. A first entity may implement method 700 for expanding their directory of external profiles in preparation for future electronic transfers.

As shown in FIG. 7, method 700 may include a step 701 of a first entity entering a request for an access token, and the name, address details, and entity repository details of the organization they wish to add to their custom directory. An access token has been defined above in this disclosure. This entered information may also include information the first entity wants to personally use to identify other second entities. For example, the first entity may associate a second entity in their directory with a certain type of recurring electronic transfer, like rent payments, or file transfers that occur on a recurring basis. A customer request, and any necessary information, may be entered into the information entry fields 504 in graphical user interface 503, as shown in FIG. 5. A custom directory may be a directory in which a first entity desires to store external profiles of a plurality of second entities so that electronic transfers may be easily initiated with directory members.

Method 700 may include a step 702 of generating an access token. Generating an access token may be achieved using techniques described herein, for example, with respect to method 600. This tokenization may be accomplished using OAuth 2, for example. Method 700 may include a step 703 of performing token introspection. Token introspection may include a mechanism for processor 501, 507 to obtain information about access tokens. For example, the token introspection may allow a server to determine whether an access token is currently available or unavailable. The token introspection may involve determining whether the token is expired, as in some embodiments, the tokens may have expiration periods. In some embodiments, Ping Identity Access Management (PING) may be used to perform token validation or token introspection. PING may be a computer application running on processor 501, 507, or another processor in a different server from server 503. If PING is an application running on processor 501, 507, then processor 501, 507 may retrieve the access token from memory 502, 508 and pass the access token to the PING application with a request for PING to run a token introspection function on the access token. If PING is an application running on another processor in a server different from server 503, then processor 501, 507 may retrieve the access token from memory 502, 508 and transmit the access token over network 505 to a server running the PING application with a request to perform token introspection. Advantageously, only the access token and request need to be transmitted, which may comprise a small string of data.

Method 700 may include a step 704 of verifying the second entity's name, address details, and entity repository details, which may include the second entity's reference number, transmit number, and repository ownership. Such verification may be achieved using techniques disclosed in method 600, for example, by using applications such as GIACT. In some embodiments GIACT may be a computer application running on processor 501, 507. In these embodiments, processor 501, 507 may retrieve the second entity's information and second entity's repository details from the second entity's internal profile stored in memory 502, 508, and processor 501, 507 may pass this information as input variables to the GIACT application with a request to verify the information. GIACT may return a verification result to processor 501, 507 that the information passed to the GIACT application is verified or is not verified. This verification may be performed to verify account ownership attributes, such as whether the account is active and in good standing, according to embodiments disclosed herein.

In some embodiments, the verification result may be transmitted over network 505. For example, this may occur if the verification result is transmitted over network 505 between processors 501 and 507, or between processor 501 and memory 502, or between processor 507 and memory 502. In such embodiments, the returned verification result may further include error checks such as a VRC or a CRC. VRC (Vertical Redundancy Check) and CRC (Cyclic Redundancy Check) are error detection methods. A vertical redundancy check may be an error checking method used on an eight-bit ASCII character. In VRC, a parity bit may be attached to each byte of data, which may be then tested by processor 501, 507 to determine whether the transmission is correct. A cyclic redundancy check may be a network method designed to detect errors in the data and information that may be transmitted over a network (e.g., 505). The CRC may be performed by performing a binary solution on the transmitted data at the sender's side and verifying the same at the receiver's end. CRC may perform modulo division on the transmitted data on the sender's side and at the receiver's side and compare the remainder results of the modulo division to confirm whether the transmitted data was corrupted or was not corrupted.

Method 700 may include a step 705 of creating a directory entry by adding the entity or organization to the external customer's directory. Creating a directory entry may include processor 501, 507 storing the second entity's name, address details, reference number, tokens, repository history, and repository status. After the second entity's name, repository ownership, address details, reference number, and transmit number, among other second entity related information have been verified in step 704, processor 501, 507 may store this information as new directory entry in memory 502, 508 as a data structure consistent with those defined in the present embodiment. The second entity's repository status and repository history may also be included as information stored in the second entity's directory entry, for example, in the second entity's internal profile.

Method 700 may include a step 706 of issuing a status to the external customer including the second entity's identifier (ID) and the second entity's access token. The second entity's access token may now be used by the first entity who owns the directory to conveniently initiate electronic transfers with the second entity. The issued status may be an indication in the external customer's mobile application indicating the new entity has been verified and added to the external customer's directory. The issued status notification may be displayed on visualization output 505 or user interface 503.

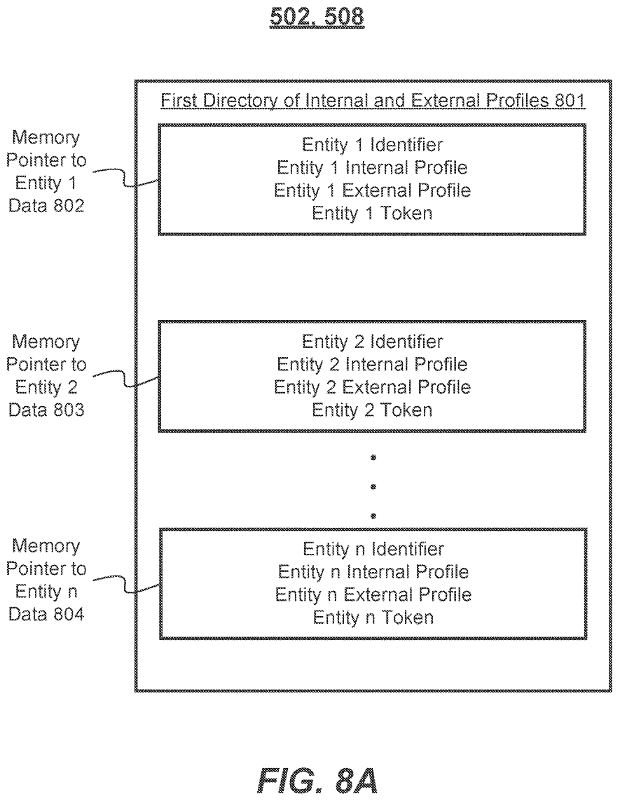

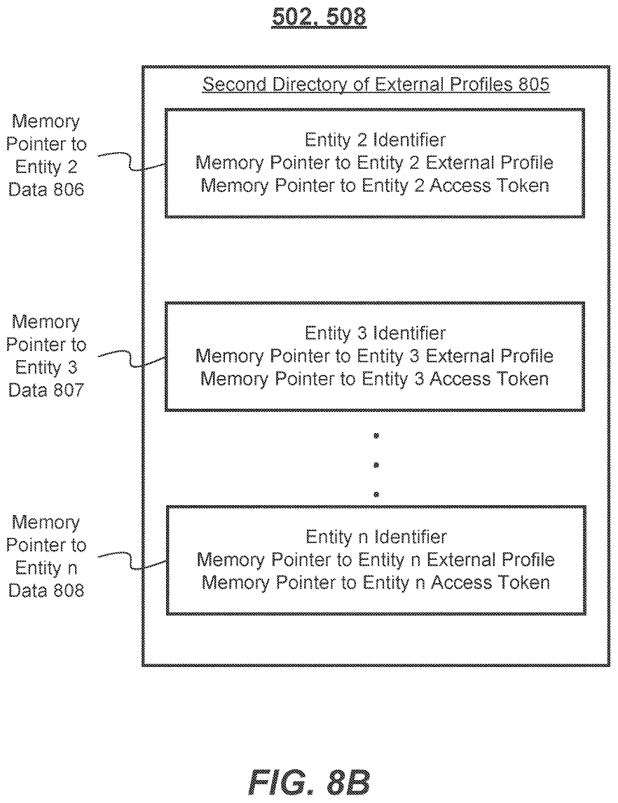

FIG. 8A illustrates an exemplary first directory of internal profiles and external profiles 801 in memory 502, 508, consistent with disclosed embodiments. A first directory of internal profiles and external profiles 801 may be consistent with embodiments disclosed herein. And a first directory of internal profiles and external profiles 801 may be created using techniques disclosed herein, for example, in reference to step 605 of method 600.

The first directory of internal and external profiles 801 may be created by processor 501, 507 storing internal profiles, external profiles, entity identifiers, and tokens in association with each other in memory 502, 508. Association between this data in memory 502, 508 may be achieved using techniques for association disclosed herein, such as by using a linked list, a look up table, by storing the information in the same database record, or by other similar methods. For example, as shown in FIG. 8A, a first directory of internal and external profiles 801 may be a linked list storing in memory 502, 508 a Memory Pointer to Entity 1 Data 802, a Memory Pointer to Entity 2 Data 803, and a Memory Pointer to Entity n data 804. The Memory Pointer to Entity 1 data 802 may be a memory pointer pointing to a location or locations in memory 502, 508 storing an Entity 1 Identification, an Entity 1 Internal Profile, and Entity 1 External Profile, and an Entity 1 Access Token. The Memory Pointer to Entity 2 Data 803 and the Memory Pointer to Entity n Data 804 may be memory pointers pointing to a location or locations in memory 502, 508 storing similar data for Entity 2 and Entity n respectively. Entity n may represent the last entity in a first directory of internal and external profiles 801, where “n” may be any number of entities. By storing this first directory of internal profiles and external profiles 801, processor 501, 507 may access any of the internal and external profiles of any entity 1 though n when needed or as appropriate. Each associated memory pointer from Memory Pointer to Entity 1 Data 802 through Memory Pointer to Entity n Data 804 may be a directory entry, and each entity 1 through n having a directory entry in the first directory of internal and external profiles 801 may be called a directory member.

In some embodiments, system 500, as shown in FIG. 5A, may be constructed so that the first directory of internal and external profiles 801 may be a central electronic transfer directory stored in memory 502, located in database 504. This central electronic transfer directory may be managed by processor 501, located in server 503 through network 505. Processor 501 may communicate with any number of entity computing devices, which may belong to different entities, over network 505, for example, including entity computing device 506. By managing this first central directory of internal and external profiles 801, processor 501 may process electronic transfers between a number of entities 1 through n according to techniques described herein. The data stored in the internal profiles may not need to be transmitted to accomplish the electronic transfers, which may lead to the computational efficiency benefits described herein. Furthermore, the first central directory of internal and external profiles 801 may access all the internal profile information necessary to determine updated entity repository histories and updated repository current statuses, as described in the present disclosure.

FIG. 8B illustrates an exemplary custom second directory of external profiles 805, consistent with disclosed embodiments. A custom second directory of external profiles 805 may be consistent with embodiments disclosed herein. The custom second directory of external profiles 805 may also be created according to techniques disclosed herein, particularly with reference to the techniques disclosed in method 700, as shown in FIG. 7. A custom second directory of external profiles 805 may be created for any entity using the electronic transfer directory service who is also a directory member of the first directory of internal and external profiles 801, as shown in FIG. 8A above. By way of example, assume Entity 1 may be a directory member in the first directory of internal and external profiles 801. Entity 1 may create customer directory of external profiles 805 in memory 502, 508. The custom second directory of external profiles 805 may include a Memory Pointer to Entity 2 Data 806, a Memory Pointer Entity 3 Data 807, and a Memory Pointer to Entity n Data 808. Each of the Memory Pointer to Entity 2 Data 806, Memory Pointer to Entity 3 Data 807, and Memory Pointer to Entity n Data 808 may be directory entries in this second directory of external profiles 805.

The second directory of external profiles 805 may be similar to the first directory of internal and external profiles 801 above, however, processor 501, 507 may store memory pointers to a location or locations in memory 502, 508 of an entity's identifier, external profile and access token. For example, as shown in FIG. 8B, Memory Pointer to Entity 2 Data 806 may include a Memory Pointer to Entity 2 Identification, Memory Pointer to Entity 2 External Profile, and a Memory Pointer to Entity 2 Access Token. Memory Pointer to Entity 3 Data 807 and Memory Pointer to Entity n Data 808 may include pointers to a memory location or memory locations storing similar data for entity 3 and entity n respectively. Entity n may be the last entity in a second directory of external profiles 805, where “n” may be any number of entities.

An entity may create a second directory of external profiles 805 as a convenient directory storing easily accessible information for other second entities that they may wish to engage in electronic transfers with, consistent with disclosed embodiments. This feature is what may make the second directory of external profiles a custom directory, custom to the entity creating it. An entity may access their custom directory on user interface 509. Processor 501, 507 may access the second directory of external profiles 805 in memory 502, 508 and retrieve the relevant data that the memory pointers are pointing to. Process 507 may transmit data about individual directory members, or the list of directory members comprising the second directory of external profiles 805 as display 513 to user interface 509, where the data may be displayed on visualization output 511. Directory members' external profiles may be displayed on visualization output 511 as icons. Displaying icons on user interface 509 will be further described in the sections below.

### Graphical User Interface Implementations and Improvements

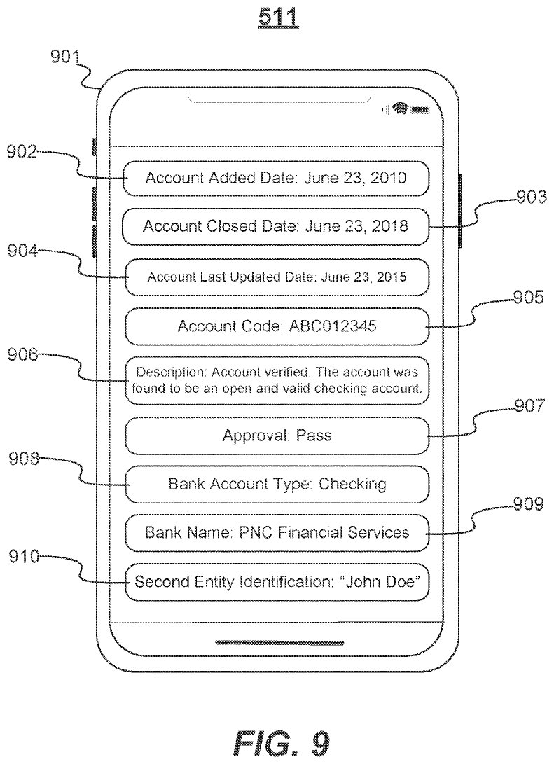

FIG. 9 illustrates an example visualization of reporting results that may be displayed on a user device, consistent with disclosed embodiments. Further elaborating on the described method 600 above, FIG. 9 represents an exemplary embodiment of what the output of step 611 may look like. Visualization output 511, as defined in FIG. 5B, may comprise a user computing device 901 as shown in FIG. 9. Entity computing device 901 may be a mobile smart phone as shown, however, entity computing device 901 may also be realized by a laptop computer, desktop computer, or other similar devices. In some embodiments, entity computing device 801 may be entity computing device 506.

As shown in FIG. 9, the output of step 611 may include an account added date (e.g., “Account Added Date: Jun. 23, 2010” 902), an account closed date (e.g., “Account Closed Date: Jun. 23, 2018” 903), an account last updated date (e.g., “Account Last Updated Date: Jun. 23, 2015” 904), an account code (e.g., “Account Code: ABC012345” 905), an account verified description (e.g., “Description: Account verified. The account was found to be an open and valid checking account” 906), an account approval (e.g., “Status: Pass” 907), a repository type (e.g., “Banking Account Type: Checking” 908), an entity repository name (e.g., Bank Name: PNC Financial Services” 909), and a second entity identification (e.g., “Second Entity Identification: John Doe” 910). An account added date may be the date the second entity's repository (e.g., bank account) was added to the first entity's directory of external profiles. An account closed date may be the date the second entity's repository (e.g., bank account) was closed by becoming inactive. The second entity's repository may be determined to be inactive using techniques disclosed herein. An account last updated date may be the date the second entity repository last engaged in an electronic transfer. An account verified description may be a description indicating the second entity's repository is active and that the second entity's details and repository details have been verified. Verification as used in this context, and determining whether an entity repository is active or inactive, may be accomplished using techniques disclosed herein. An account approval may be an indication that the electronic transfer directory service will automatically approve of electronic transfers made with this second entity directory. As described in method 600, the electronic transfer directory service may automatically approve electronic transfer or automatically block electronic transfers based on the status and history of the second entity repository. Therefore, this displayed account approval may state “Pass” if the electronic transfer directory service will automatically approve an electronic transfer with this second entity. This displayed account approval may state “Blocked” if the electronic transfer directory service will automatically block electronic transfers with this second entity. The repository history and status of the second entity repository may be determined using techniques disclosed herein. A repository type may indicate what type of entity repository the second entity repository is. For example, the repository type may be a checking bank account, a savings bank account, or a file storage folder in memory 502, 508. The entity repository name may be a string of data that identifies the owner or manager of the second entity repository. For example, if the second entity repository is managed by PNC Financial Services, then the entity repository name may be “Bank Name: PNC Financial Services.” A second entity identification may be any string of data the first entity may use to identify the second entity, consistent with the definition of second entity identification set forth in this present disclosure. For example, if the second entity is a person, the second entity identification may be that person's name. The first entity may set customized second entity identifications by typing letters and/or numbers into information entry fields 510. The output of step 611 may also include any combination of the aforementioned data, along with any additional similar data.

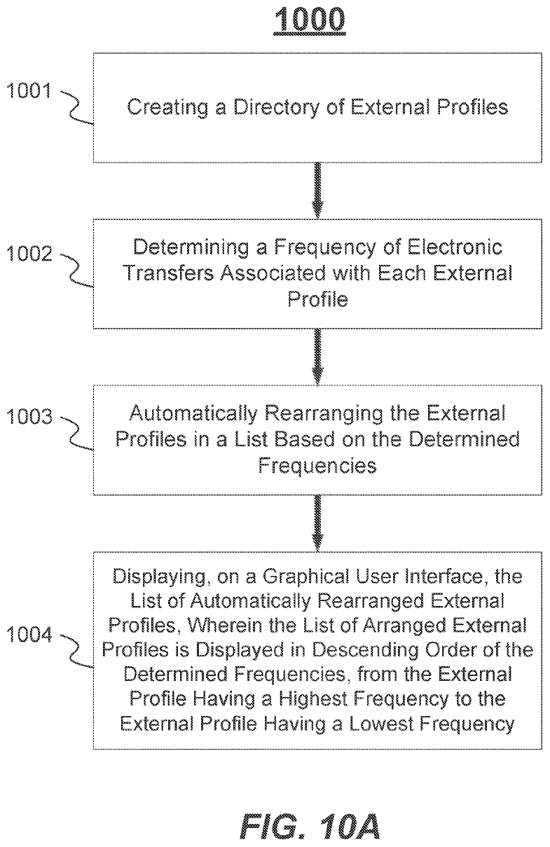

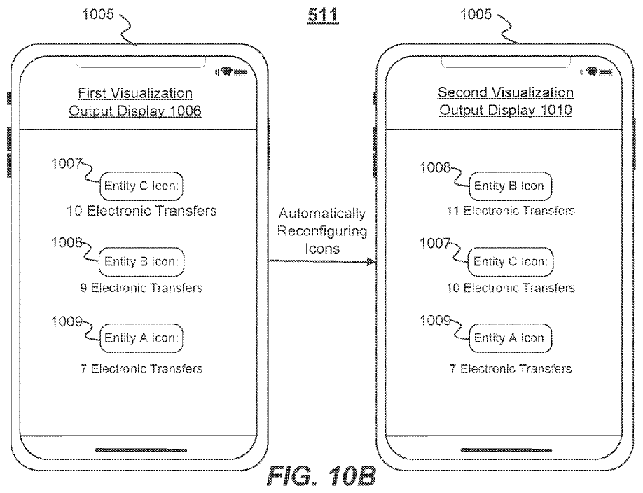

FIG. 10A presents a flowchart illustrating an exemplary method for automatically rearranging icons associated with entities on a graphical user interface based on determined frequencies of electronic transfers associated with each external profile, consistent with disclosed embodiments. Other implementations of method 1000 may be used, for example, by changing the determined criteria upon which the automatic rearrangement depends. Any determined or updated criteria disclosed in the present disclosure may be used as a prompt to automatically rearrange icons on a graphical user interface. The purpose of method 1000 may be to present an improved graphical user interface that may take advantage of the features and functions of the electronic transfer directory service. The purpose of method 1000 may also be to make the disclosed embodiments of the electronic transfer directory service user friendly for entities.

Method 1000 may include a step 1001 of a first entity creating a directory of external profiles associated with second entities. A directory of profiles may be a directory consistent with the present disclosure. Similarly, external profiles have been defined above in this disclosure. The directory of external profiles may be created consistent with methods disclosed herein, for example, a directory of external profiles may be created via method 700, or via method 600. Step 1001 may be performed by processor 501, 507. The created directory of external profiles may accordingly be stored in memory 502, 508.

Method 1000 may further include a step 1002 of determining a frequency of electronic transfers associated with each external profile. A frequency of electronic transfers associated with each external profile may indicate how often a first entity, who owns the directory, makes electronic transfers with any of the second entities associated with the external profiles in the first entity's second directory of external profiles. For example, the directory may instruct processor 501, 507 to store a value in memory 502, 508 reflecting how many times the first entity has made electronic transfers with any of the entities associated with the external profiles in the directory of external profiles. Accordingly, determining a frequency of electronic transfers associated with each external profile may be accomplished by processor 501, 507 reading this value which may indicate how many electronic transfers have been completed between the first entity and each of the second entities. In some embodiments, the first entity may specify in information entry fields 510 a specific time frame date range within which to determine the frequency of electronic transfers for the stored external profiles. For example, the first entity may specify the user interface 509 should be rearranged based on a frequency of electronic transfers made, for example, in the past week, or in the past month, or in the past year. In these embodiments, processor 501, 507 may store a list in memory 502, 508 of all the electronic transfers completed between the first entity and this specific second entity, along with the dates upon which the electronic transfers were completed. Therefore, if the first entity specifies a date range in information entry fields 510, processor 501, 507 may access the stored list in memory 502, 508 and sum all electronic transfers made between the first entity and that specific second entity within that date range.

Method 1000 may further include a step 1003 of automatically rearranging the external profiles in a list based on the determined frequencies. Step 1003 may also be performed on processor 501, 507 as processor 501, 507 may access the directory of external profiles and the determined frequencies in memory 502, 508. In some embodiments, processor 501, 507 may generate the list by comparing the values stored in memory 502, 508 that were discussed previously in step 1002. As these values are updated in memory 502, 508 which may occur as more electronic transfers are made, processor 501, 507 may automatically rearrange the list based on comparing the values as they are updated. Rearrange may mean changing the external profiles' positions in the list. Rearranging may happen in several different ways. For example, external profiles may be arranged in the list in ascending order so that the external profile associated with the second entity having a highest frequency of electronic transfers may be at the top of the list, and so that the external profile associated with the second entity having a lowest frequency of electronic transfers may be at the bottom of the list. Alternatively, the list may be arranged in descending order, so that the external profile associated with the second entity having a lowest frequency of electronic transfers may be at the top of the list, and so that the external profile associated with the second entity having a highest frequency of electronic transfers may be at the bottom of the list. The list may be a data structure consistent with data structures described herein. In some embodiments, the list may be a data structure storing a list of memory pointers, pointing to the locations in memory 502, 508 of the stored external profiles.

If the automatic rearranging is performed at processor 501 included in server 503, then the list may be transmitted over network 505 to entity computing device 506 for display. Processor 507 at entity computing device 506 may receive the list and communicate it as display 513 to user interface 509 to be visually displayed on visualization output 511. In the event the list is automatically rearranged by processor 507, included in entity computing device 506, the list may be communicated as display 513 from processor 507 to user interface 509 to be visually displayed on visualization output 511.

Method 1000 may also include a step 1004 of displaying, on a graphical user interface, the list of automatically rearranged external profiles, where in the list of arranged external profiles is displayed in descending order of the determined frequencies, from the external profiles having a highest frequency to the external profile having a lowest frequency. The graphical user interface may be visualization output 511 of user interface 509, as shown in FIG. 5B. An external profile having a highest frequency may be the external profile in the directory of external profiles associated with the second entity with which the first entity has engaged in the most electronic transfers. The external profile having a lowest frequency may be the external profile in the directory of external profiles associated with the second entity with which the first entity has engaged in the fewest electronic transfers. For example, if a person, the first entity, has made five electronic transfers in the past month with a grocery store, a second entity, and three electronic transfers in the past month with a gas station, another second entity, then the grocery store would be listed above the gas station in the list of automatically rearranged external profiles. According to method 1000, the person's graphical user interface may be automatically updated and rearranged if they develop a higher frequency of electronic transfers with the gas station at any given time.

Method 1000 leads to an improved graphical user interface by automatically keeping at the top of the graphical user interface the external profiles, and entity names, that the entity makes the most frequent electronic transfer with. As a whole, method 1000 recites a specific manner of automatically displaying icons to the user first entity based on the frequency of electronic transfers which provides a specific improvement over prior systems, resulting in an improved user interface for electronic devices. Conventional systems may require that a first entity search in their directory for a second entity that they wish to initiate an electronic transfer with. Searching may require scrolling through the directory entries, which may be numerous, or typing into information entry fields 510 the name or identification of a second entity to pull up the external profile that second entity may be associated with. However, the automatically rearranging feature of the electronic transfer directory service may allow a first entity to more quickly find a second entity that they wish to initiate an electronic transfer with because the second entities that the first entity most frequently engages in electronic transfers with may automatically be positioned at the top of visualisation output 511. Thus, the electronic transfer directory service may reduce the amount of time that the first entity needs to spend searching for second entities they wish to engage in electronic transfers with.

FIG. 10B illustrates an exemplary display on a graphical user interface wherein icons representing entities are automatically rearranged based on the frequency of electronic transfers made between the first entity and the entities associated with the external profiles, consistent with disclosed embodiments. In some embodiments, FIG. 10B illustrates an exemplary output of method 1000, as shown in FIG. 10A, on a graphical user interface. As shown in FIG. 10B, an entity, a person for example, may view their directory of external profiles on a graphical user interface like on visualization output 511 of user interface 509, as shown in FIG. 5B. In FIG. 10B, the graphical user interface may be included in a first entity's computing device 1005 like a mobile phone, for example.

FIG. 10B illustrates a before and after display on visualization output 511. The first visualization output display 1006 shows three entities displayed as icons, entity icon A 1009, entity icon B 1008, and entity icon C 1007. As shown in FIG. 10B, entity icon A 1009, entity icon B 1008, and entity icon C 1007 are ranked by the frequency of electronic transfers the first entity has made with each of the respective second entities A, B, and C. FIG. 10B illustrates how the display on visualization output 511 may be automatically updated as the frequency of electronic transfers changes. The second visualization output display 1010 may be a display on a graphical user interface of first entity's computing device 1005. The second visualization output 1010 illustrates the display after the entity icon A 1009, entity B icon 1008, and entity C icon 1007 are automatically rearranged. The automatic rearranging may be performed because the frequency of electronic transfers changed. For example, the frequency of electronic transfers made between the first entity and entity B changed from nine electronic transfers to eleven electronic transfers, thereby surpassing the frequency of electronic transfer made between the first entity and entity C. Accordingly, Entity B Icon 1008 was automatically rearranged to be displayed above Entity C Icon 1007 on the second visualization output 1010.

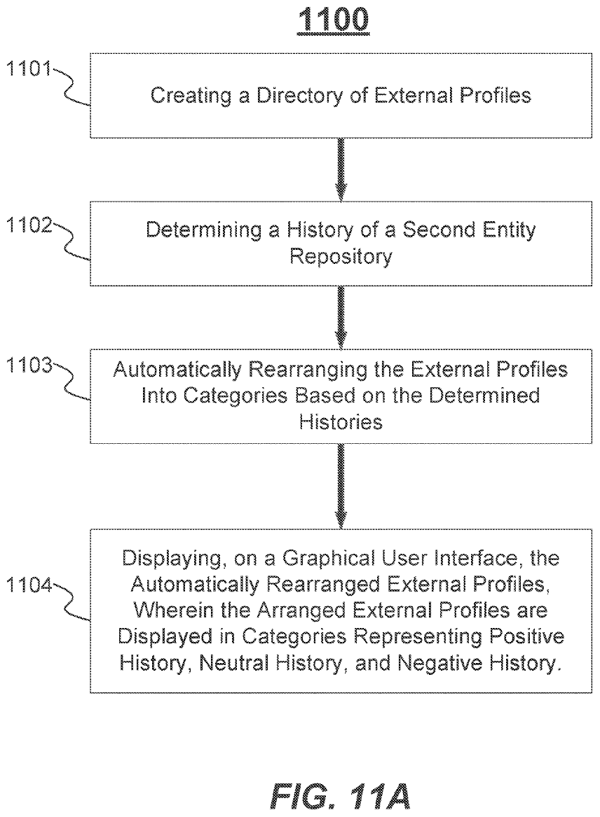

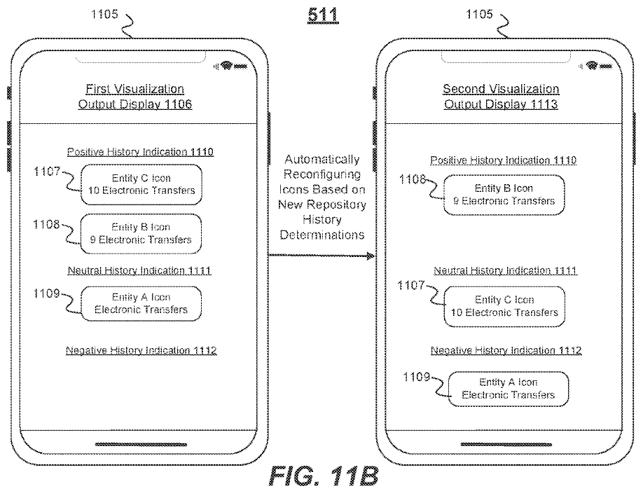

FIG. 11A presents a flowchart illustrating an exemplary method for automatically rearranging icons associated with entities on a graphical user interface based on updated entity repository histories, consistent with disclosed embodiments. Method 1100, as shown in FIG. 11, may be implemented in a similar manner and for a similar purpose to method 1000, as shown in FIG. 10A, except that method 1100 may use a different criterion for automatically rearranging the icons on the graphical user interface.

Method 1100 may include a step 1101 of creating a directory of external profiles. Step 1101 may include techniques similar to those discussed above, for example, in step 1001. Method 1100 may include a step of 1102 of determining a repository history of a second entity repository. A history of a second entity repository may be determined in a manner consistent with that disclosed in step 609 of method 600, as described above in the present disclosure. Method 1100 may include a step 1103 of automatically rearranging the external profiles into categories based on the determined histories. Each category may be a list, the list may be a data structure in memory 502, 508 consistent with embodiments described herein. These lists may be created by processor 501, 507 associating external profiles based on their stored current histories. For example, processor 501, 507 may query memory 502, 508 for each external profile having a positive history, and then retrieve a pointer to a location in memory 502, 508 of each external profile having a positive history. Processor 501, 507 may then generate a list of pointers pointing to the locations in memory of each external profile having a positive history. This generated list of memory pointers may be stored by processor 501, 507 in memory 502, 508. A similar list may be generated for external profiles having a neutral history, and for external profiles having a negative history. Processor 501, 507 may query memory 502, 508 for each external profile having a positive history, a neutral history, or a negative history because each external profile may store a value indicating the history of the second entity repository associated with the external profile. This value may be determined, for example, according to techniques referenced in step 609 of method 600 by processor 501, 507. After processor 501, 507 determines the history of the second entity repository, processor 501, 507 may store a value in the relevant second entity's external profile in memory 502, 508 reflecting that determined history.

Step 1103 may rearrange these lists of external profiles having positive histories, neutral histories, and negative histories at any time a repository history is redetermined. The lists may be rearranged by processor 501, 507 accessing the lists in memory 502, 508 and moving memory pointers into the new correct lists. By way of example, assume three lists exist in memory 502, 508, a list of external profiles having a positive history, a list of external profiles having a neutral history, and a list of external profiles having a negative history. Further assume that a specific second entity repository owned by business 1 may be associated with an external profile in memory 502, 508, consistent with techniques described herein. Further assume that one week ago processor 501, 507 determined that business 1's entity repository has a positive history, and accordingly processor 501, 507 stored a pointer pointing to the location in memory 502, 508 of business 1's second external profile. This may be the list of external profiles having a positive history, and processor 501, 507 may store this list in memory 502, 508. Now assume that one week later, processor 501, 507 determines that business 1's entity repository has a neutral history. Processor 501, 507 may update the value indicating repository history in business 1's external profile in memory 502, 508. Processor 501, 507 may also automatically move the memory pointer pointing to the location in memory 502, 508 of business 1's external profile into the list of external profiles having a neutral history. Accordingly, the lists of external profiles having positive, neutral, and negative histories may be automatically rearranged by swapping memory location pointers between the lists when repository histories are redetermined.

These histories may be redetermined at any given time. For example, an entity user may wish to update the histories of the second entity repositories associated with the external profiles stored in their directories. In such a case, a user may enter a request into information entry fields 510 of user interface 509 to redetermine these histories, and therefore automatically rearrange the external profiles based on the determined histories. By way of example, if second entity repositories were bank accounts storing funds, and if the second entities were businesses, then the first entity may have a directory listing external profiles of these businesses. These external profiles may be related to bank accounts held by the businesses. The first entity may wish to check up on the financial health of the businesses they engage with in their directory. As a solution, the first entity may want to redetermine the histories associated with these bank accounts for convenient viewing.

Histories of second entity repositories may also be determined in the course of initiating electronic transfers by using method 600. When a second entity repository history is determined as part of step 609, that may prompt the external profiles to be automatically rearranged based on the updated determined history of the second entity repository that is now engaging in an electronic transfer with the first entity. By way of example, if the second entity repository may be a bank account, the first entity may want to see the financial health of that bank account automatically updated on their graphical user interface if anything about that bank account's history has changed since the last electronic transfer between the first entity and the second entity.

Method 1100 may include a step 1104 of displaying, on a graphical user interface, the automatically rearranged external profiles, wherein the arranged external profiles are displayed in categories representing positive history, neutral history, and negative history. Displaying entities may comprise displaying icons on the graphical user interface. Each icon may represent information stored in the associated second entity's external profile as stored in the first entity's directory, such as the second entity's name, unique identifier, or second access token. Displaying the external profiles in categories may comprise displaying the icons in visually different areas on the graphical user interface. The graphical user interface may be user interface 509, wherein the icons are visually displayed on visualization output 511. The displaying may occur at an entity computing device 506, for example. By way of example, the visualization output 511 may have three sections titled “Positive History Indication,” “Neutral History Indication,” and “Negative History Indication.” The icons representing the external profiles may be visually arranged into these different sections on visualization output 511 based on the determined histories of the entity repositories.

FIG. 11B illustrates an exemplary display on a graphical user interface wherein icons representing entities are automatically rearranged based on updated determined entity repository histories, consistent with disclosed embodiments. FIG. 11B illustrates an exemplary visual output of method 1100 as described in FIG. 11A. FIG. 11B is similar to FIG. 10B, described above, in that it illustrates a before and after image of a first visualization output 1106 and a second visualization output 1113 on a first entity's computing device 1105. However, the automatic rearranging in FIG. 11B is based on a different determined criterion. The transformation of the visual arrangement of Entity A Icon 1109, Entity B Icon 1108, and Entity C Icon 1107 is based on a criteria of the determined repository history associated with each of the respective entities. Entity repository history may be determined according to embodiments disclosed herein. Specifically, entity repository histories may be determined according to step 609 in method 600, as shown in FIG. 6.

As shown in FIG. 11B, the first visualization output display 1106 shows three entities displayed as Entity A Icon 1109, Entity B Icon 1108, and Entity C Icon 1107. The three entity icons 1107, 1108, and 1109 may be divided into categories based on their respective entity repository histories. The first visualization output 1106 may have different visual section outline, these visual sections may include sections for entity icons having a positive history indication 1110, a neutral history indication 1111, and a negative history indication 1112.

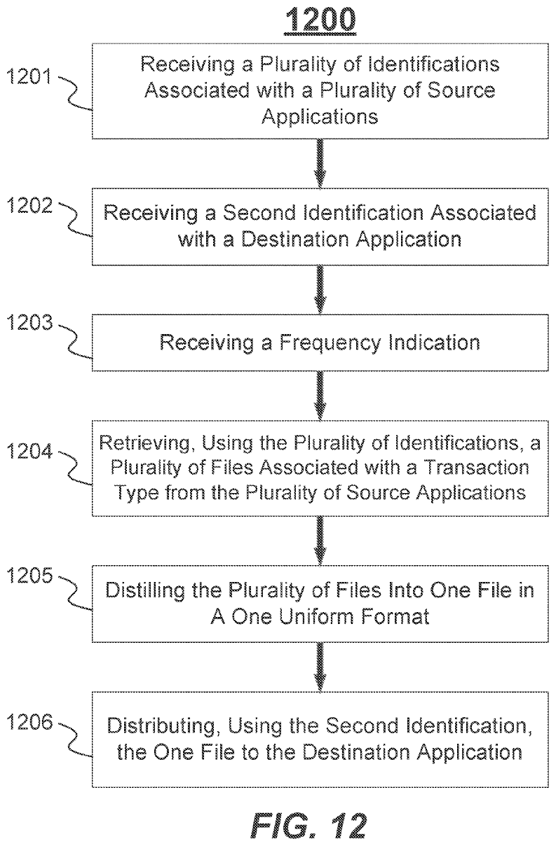

The second visualization output 1113, as shown in FIG. 12B, illustrates what visualization output 511 may look like visually after the automatic reconfiguring. After the automatic reconfiguration, Entity B Icon 1108 is displayed in the positive history indication 1110 section of the second visualization output 1113, Entity C Icon 1107 is displayed in the neutral history indication 1111 section, and Entity A Icon 1109 is displayed in the negative history indication 1112 section. Based on updated data sets, entity C is now associated with a neutral history indication, and entity A is now associated with a negative history indication. Accordingly, Entity A Icon 1109 and Entity C Icon 1107 where automatically reconfigured to be displayed in the appropriate sections of the second visualization output 1113.

Software implementations of the methods disclosed herein may be accomplished by any software implementation capable of achieving the disclosed methods. However, certain software functions may be particularly helpful for implementing the methods disclosed herein. For example, implementations of an electronic transfer directory service, and the methods disclosed herein, may need to create, update, delete, and retrieve information within internal or external profiles or within directories. Some exemplary software functions that maybe used to perform the disclosed methods may include network function (which may create a new profile or directory), response functions (which may generate responses, for example, JSON responses, responses may also include the various errors or codes disclosed), put functions (which may update existing profiles or directories), get functions (which may obtain information from an existing profile or directory, such as, for example, tokens), and post functions (which may add repositories or accounts to an existing entity profile within the directory).

A combination of such functions may be used to create, update, delete, and retrieve information within internal or external profiles or within directories. One implementation of a get function may get all entities within the profile or directory, this may be accomplished by passing parameters such as a path, organization ID, and a schema. Another implementation of a get function may fetch entity details within the profile or directory via an organization ID, this may be accomplished by passing parameters such as the path, organization ID, and a schema. An implementation of a put function may update an existing entity within a profile or directory, this may be accomplished by passing parameters such as a path, organization ID, and a schema. A delete function may be used to delete existing entities within a directory, this may be accomplished by passing parameters including a path, organization ID, and a schema. An implementation of a post function may add account(s) to an existing entity within a profile or directory by passing parameters such as a path, an entity ID, and a schema. An implementation of a post function may delete tokens or accounts from an entity within a profile or directory by passing parameters such as a path, organization ID, and a schema. An implementation of a get function may get account details for a provided token for a given entity, this may be accomplished by passing parameters such as a path, organization ID, and a schema, and a token. An implementation of a post function may get organizations matching search criteria by passing a number of criteria, which may be, for example, search terms, to initiate a search for entities. An implementation of a post function may initiate a request for access a private entity within a profile or directory, this may be accomplished by passing parameters such as a path, a requestor organization ID, and a schema.

An organization ID may be, for example, a number associated with an entity that the external or internal profile may use to define that entity. A path may be a string of characters used to uniquely identify a location in a directory structure, for example, a path may be like a file path. A schema may be a reference to a computer implemented function, like a specific block of code that performs a desired function. In some embodiments, a schema may be an indication of which computer implemented function is to be carried out.

An implementation of a get function may be to retrieve a list of entities to which access was requested within the directory. This may be accomplished by passing parameters such as a path, organization ID, and a schema. Another implementation of a get function may be to retrieve a list of entities which requested access to the current entity. Another implementation of a post function may be for a requesting entity to approve or deny an access request from another entity, and the implementation may allow the requestee entity to grant access to some partial/all access tokens accounts as desired. This may be accomplished by passing parameters such as a path, organization ID, and a schema. Another implementation of a get function may be to get a list of entities and token to which access was approved or granted, this may be accomplished by passing parameters such as a path, organization ID, and a schema. Another implementation of a get function may be to retrieve a list of entities that an entity has been approved for, this may be accomplished by passing parameters such as a path, organization ID, a schema, and a query, such as a request to show the account number. Another implementation of a get function is to retrieve a list of sub/child entities of entities that have already been approved or denied, this may be accomplished by passing parameters such a path, organization ID, and a schema. Another example of a post function may be to initiate a multi payment request from an entity within a directory, this may be accomplished by including a request for a RTP, WIRE, or ACH payment, as described above. Another implementation of a get function is to get the status of a single payment within the multipayment request of payment type RTP. WIRE, or ACH, this may be accomplished by passing parameters such as a path, a multipayment ID, a schema, and a trace ID. A multipayment ID may refer to a multipayment order, which may be an order that combines several payments together. A trace ID may refer to a number used to track inbound and outbound ACH transfers. Another implementation of a get function is to get the ten most recent payments associated with a customer reference, which may be accomplished by passing parameters such as a path, reference ID, and a schema. Another implementation of a post function is to allow master limited partnerships to post payment status.

Schemas, as mentioned above, may include directory data transfer object (“DTO”), which may include a directory or profile name, a directory or profile type, client key, activation date, profile identifier, entitlement eligibility, and payments eligibility. DTO may be a data transfer object, a directory or profile DTO may be an object that carries data between processes. A possible schema may also include update a directory or profile DTO, which may include a token, directory or profile name, AVS identification type and value, a profile identifier, and entitlement eligibility, a payments eligibility, and an indication of who requested the update. A possible schema may also include an organization account request, which may include an account name, account number, account type, routing number, routing type, and currency type. A possible schema may also include an organization account response, which may include an account name, account number, routing number, currency type, and account type.

A possible schema may also include a repository basic info DTO, which may include a token and transmit number. In some embodiments, this possible schema may include an account basic info DTO, which may include a token and routing number. A possible schema may also include an approved organization account response, which may include a token and routing number. A possible schema may also include an approved account basic info DTO, which may include a token and routing number. A possible schema may also include an entity request, which may include an organization name, Pinacle® Comp ID, email, address, identity type and value, privacy indication (which may be private or public), tax ID, the entity's role (which may be a payer, payee, or both), account number, and an effective date. A Pinacle® Comp ID may be an identifying number that may be used by PNC's platform application Pinacle®.

A possible schema may also include a get all organization response, which may include an organization ID, entity name, Pinacle® Comp ID, phone number, email, address, identity type and value, tax identifier, revision number, organization role, privacy indication, effective date, and accounts. A possible schema may also include an organization response, which may include an organization ID, and organization name, a Pinacle® Comp ID, a phone number, email, address identity type and value, tax ID, organization role, privacy indication, effective date, and account type.

A possible schema may also include a save organization response, this may include an organization ID, and organization name, Pinacle® Comp ID, phone number, email, address, identity type, identity value, tax identifier, organization role, privacy, effective date, and accounts. A possible schema may also include an organization update request, which may include an organization name, Pinacle® Comp ID, phone, email, address, and organization role. A possible schema may also include an organization update response, which may include an organization name, Pinacle® Comp ID, phone number, email, address, and organization role. A possible schema may also include an organization account delete, which may include a routing number and token. A possible schema may also include get basic token information, which may include an account number, account name, and routing number. A possible schema may also include an organization search request, which may include an address, organization name, tax identification number, national provider identifier, universally unique identifier, and the requester organization ID.

A possible schema may also include an organization search response, which may include total pages, total elements, current page number, page size, and an organization list. A possible schema may also include an organization search result DTO, which may include an organization ID, organization name, phone number, email, address, privacy, and accounts. A possible schema may also include pending approval organization access, which may include organization name, organization ID, and an address. A possible schema may also include organization access, which may include organization ID, organization name, address, and accounts. A possible schema may also include organization access decision, which may include the requestor organization, an approval indication, and accounts. A possible schema may also include organization access request, which may include the requester organization ID and the requested organization ID. A possible schema may also include transfer amount, which may include the amount and currency of a transaction. A possible schema may also include payments, which may include a customer reference, preferred payment type (for example, RPT, WIRE, ACH, or ITR), creditor info (for example, a token, organization ID, or routing number), the transfer amount, the accounting entity, standing entry class code, requested execution date, transaction code, related remittance information, transaction description, settlement date indication, clearing type, confidentiality flag, instructee intermediary repositories or banks (which may include, routing type, organization ID, routing number, or an indication that banking systems like Swift or ABA may be used), product type, channel, purpose of payment, transfer code type, FX quote ID, address, ultimate party (which may include name, account number, and address), remittance acceptance time or remittance information. FX quote ID may refer to the price of one currency in terms of another currency.

A possible schema may also include payment request, which may include a multipayment ID, an initiating party ID, an organization ID, routing number, instructor account number and type, the currency, and payments. A possible schema may also include a payment response, which may include a multipayment ID, a timestamp, status code, customer reference ID, preferred payment type, trace ID, and amount. A possible schema may also additional information, which may include a type (for example, an error), a reason code (for example, cancel), a user ID, and addendal information. A possible schema may also include a payment status response, which may include a status code, a timestamp, an initiating party ID, a multipayment ID, trace ID, payment type, executed payment type, payment reference, clearing reference, customer reference, transfer amount, and additional information. A possible schema may also include a customer reference status response, which may include a payment. A possible schema may also include an update payment status request, this may include an event type, an initiating party ID, sender ID, client ID, multipayment ID, instruction ID, trace ID, customer reference, transfer amount, payment reference, clearing reference, payment type, executed payment type, status code, reason code, reason description, and addendal information. A possible schema may also include a master limited partnership status request, which may include a status code and status description related to master limited partnerships.

For example, to initiate an RTP payment, one embodiment may include the following example input information, summary “RTP initiation sample”, multipayment ID “uuid-1234-5678-91011,” initiating party ID “pncpskapi,” debtor organization ID “1234,” debtor token “123456789,” routing number “123456789,” and for payments, a customer reference “PP123456789,” preferred payment type “RTP,” account entity “credit,” requested execution date “22-04-28,” creditor organization ID “9876,” creditor token number “987654321,” creditor routing number “987654321,” and the transfer amount “10500.” Similar examples maybe used to implement ACH, ITR, or WIRE payments.

### CFE

FIG. 12 presents a flowchart illustrating an exemplary method for distilling files of different formats into a uniform format and distribution of the files to destination applications, according to embodiments of the present disclosure. In some embodiments, the electronic transfer directory service may further automatically distil and consolidate multiple electronic files into a single convenient format, and may distil the electronic files according to a schedule. Entities using the electronic transfer directory service may wish to perform electronic transfers that require transferring several electronic files at once, or that may require transferring electronic files of different formats. The CFE feature of the electronic transfer directory service creates a solution allowing entities to do this more easily. As an example, if a first entity wants to transfer electronic data representing a plurality of checks to a second entity, the CFE component of the electronic transfer directory service may allow the first entity to consolidate all the electronic checks into a signal electronic transfer and distribute the electronic transfer according to a schedule. CFE may be a mainframe batch collection and distribution system that receives and processes transactions for many source applications.

As shown in FIG. 12, method 1200 may include a step 1201 of receiving a plurality of identifications associated with a plurality of source applications. An identification may be a way to identify a source application. For example, if an entity wishes to receive electronic transfers from a data structure that is a Universal Resource Locator (URL), the identification may be the URL. The plurality of source applications may be originating applications that the electronic transfer may be made from. The source application may be an application that an entity is operating on entity computing device 506 to initiate and coordinate electronic transactions from their entity repository to other entity repositories. For example, the source application may be an implementation of the electronic transfer directory service on entity computing device 506.

Method 1200 may include a step 1202 of receiving a second identification associated with a destination application. The destination application may be an application to which the electronic transfer is made. For example, the electronic transfer directory service may coordinate electronic transfers from a plurality of source applications to a destination application. The second identification may be similar to the first identification defined above, except that it may identify a destination application. In some embodiments, the second identification may be a mnemonic labelling the destination application. A mnemonic labelling the destination application may be an abbreviation of letters identifying the destination application. For example, PSK indicates the destination application may be a payment directory service.

In some embodiments, the destination application may be Core®, ACLS (Advanced Consumer Lending System)®, FIS (Fidelity National Information Service)®, DAP (Delivered as Promised)®, CAA (Commercial Account Analysis)®, Pinacle®, or some combination thereof. Core® may be a destination application with an interface that allows employees within an entity to upload and manage assets. ACLS® may enable users to process any type of retail consumer loan and introduce new credit products or refine existing ones. FIS® may be a destination application that provides financial services technology and outsourcing services. DAP® may be a peer-to-peer payment application. CAA® may be a cash management billing system that allows financial institution to maximize treasury service fee income. Pinacle® may be a destination application that may offer secure access to cash position information and may offer access to business management tools.

Method 1200 may include a step 1203 of receiving a frequency indication. A frequency indication may be an indication of how often electronic transfers should be made on a recurring basis. Electronic transfers may be consistent with definitions provided above in the present disclosure. When a frequency indication is received, it may comprise instructions to start an electronic transfer. CFE may offer a solution for entities to conveniently schedule electronic transfers on a recurring basis with other entities. This may be especially advantageous in combination with an entity's directory, which already stores the necessary external profiles and tokens to achieve these recurring electronic transactions in an efficient manner. For example, in some embodiments, the frequency indication may one or more of daily, weekly, monthly, or any other desired time period. In some embodiments, a user may also account for holidays in the frequency indication. For example, the user may indicate that on a holiday, the electronic transfer should not be scheduled, that the electronic transfer should be scheduled anyway, or that the electronic transfer should occur on the next or previous processing days. The frequency indication may be used by a scheduler, for example, CA7 Mainframe, to trigger electronic transfers which may initiate file distributions. CA7 Mainframe may be a job scheduling/workflow automation software package.

The frequency indication may be received at processor 501, 507 and may comprise user input 512 that an entity may input into information entry fields 510 on user interface 509. An entity may input information when initiating an electronic transfer using entity computing device 506.

Method 1200 may include a step 1204 of retrieving, using a plurality of identifications, a plurality of files associated with a transaction type from the plurality of source applications. The plurality of identifications may be consistent with the identifications used to identify source applications as defined above in the present disclosure. The files may comprise the electronic files that are intended to be transferred. For example, a group of files may comprise a group of several checks that an entity wants to process as part of an electronic transfer of funds from their entity repository to another entity repository. The transaction type may be consistent with the different types of electronic transfers discussed, for example, with respect to step 611 of method 600.

The plurality of files may be stored in the first entity's repository, which may itself be stored as a data structure in memory 502, 508. The plurality of files may be associated using means of association described above in the present disclosure, such as by using a linked list, a look up table, by storing the information in the same database record, or by other similar methods. These files may then be accessed by processor 501, 507. In some embodiments, processor 501, 507 may access files in memory 502, 508 by using a call to a data access layer function. Data access layer may be a layer in an application that provides easy and simplified access to data stored in persistent storage, such as an entity relational database or any database for that matter. In some embodiments, input files for CFE may be created using Microsoft Excel XLS format of the data from the plurality of source applications.

In some embodiments, the retrieved plurality of files may include packed bytes. Packed files may mean, for example, a 255 Byte Detail file and a 150 Byte ICF file (Interface Control File), or other similar file sizes and types. In some embodiments, the retrieved plurality of files may include non-packed bytes. Non-packed files may mean, for example, a 400 Byte Detail file and a 250 Byte ICF file, or other similar file sizes and types. The ICF may be a summary, by bank or by posting application, of what is on the Detail file. In some embodiments, the file may be a TCH ABA file. A TCH (The Clearing House) file may contain information for performing an automated clearing house transaction, which may be an electronic transaction that requires a debit from an originating bank and a credit to a receiving bank. Transactions go through a clearinghouse that batches and sends them out to the recipient's bank. In other embodiments, the files may be a plurality of checks.

In response to receiving a frequency indication, method 1200 may include a step 1205 of distilling the plurality of files into one file in a one uniform format. A uniform format may mean that rather than transmitting a plurality of electronic checks, a single electronic file consolidating all the data from the plurality of electronic checks may be sent. Distilling is the process of consolidating this plurality of electronic files into a signal uniform format. In some embodiments, the distilling may include using processing functions such as Perfect Placement®, CDA (Controlled Disbursement Account) holdovers, account number posting, and XREG processing (external regressors processing functions). CFE may subsequently split and/or accumulate similar transactions using processing these functions. Perfect Presentment® may be a verification service. CDA stands for controlled disbursements, CDA may allow a business to determine which checks will be posted to their bank account each day, depending on funding needs. Account number postings may be a recorded ledger showing transactions that have been fully completed. XREG processing may be a regression model that may use Autoregressive Integrated Moving Average (ARMIA), ARMIA may be a statistical analysis model that uses time series data to predict future values based on past values. This distilling step, along with these processing applications, may be run on professor 501, 507 which has access to the plurality of files to be distilled in memory 502, 508. In some embodiments, CFE may intake a plurality of checks as input files. CFE may distil the plurality of checks into a single file accumulating the data from the plurality of checks using the above processing functions. The single file of consolidated, accumulated data may be stored in memory 502, 508 and the original files may be discarded. Therefore, in some embodiments, the original files from the plurality of source applications may be stored in memory 502, 508 only for as long as is needed to distil them into the single file.

In response to receiving a frequency indication, method 1200 may include a step 1206 of distributing, using the second identification, the one file to the destination application. The second identification and destination application may be consistent with the definitions presented above. Distributing may be understood to mean completing an electronic transfer as defined in the present disclosure. Therefore, distribution may include processor 501, 507 accessing the one file in an entity repository data structure stored in memory 502, 508 and transmitting the file over network 505 to a second entity repository associated with the destination application. The destination application may additionally monitor the distribution and indication when the file distribution is complete. If the file distribution is not completed or received within a certain predetermined amount of time, or if the file is under an incorrect name or in an incorrect format, a bit may be set to 1 indicating the file distribution has failed. Alternatively, if no issues are detected, a bit may be set to 0 indicating that the fie distribution was successful. A notification may be generated based on whether the bit is set to 0 or 1. Such a notification may be displayed on visualization output 511 of the user interface 509, as shown in FIG. 5B. In some embodiments, the file distribution may be successful when it reaches a network attached storage location like a cloud based fie storage application. Step 1205 may improve computer performance speed because processor 501, 507 as shown in FIGS. 5A and 5B, need only distribute a uniform file format to a destination application in step 1206, instead of a plurality of files in separate formats. Computer performance speed may relate to how many file formats need to be distributed by processor 501, 507. Therefore, step 1205 may improve computer performance speed because step 1205 allows processor 501, 507 to distribute fewer file formats in step 1206. For example, in some embodiments that utilize CDA, the input files may be a plurality of checks. This plurality of checks may be transformed into a single report indicating which checks will post each business day.

In some embodiments, method 1200 may include the additional step of overriding the response to the frequency indication in response to an override indication. Such an override indication may be entered by a user in the information entry fields 510, shown in FIG. 5B.

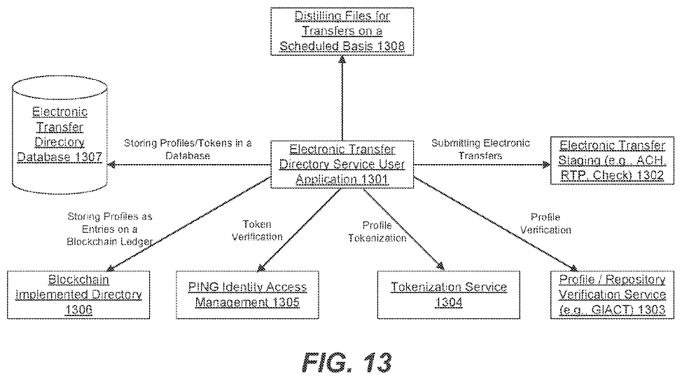

FIG. 13 shows an exemplary interconnection of the modules that may be performed by the electronic transfer directory service system 500. The electronic transfer staging 1302 and PING Identity Access Management 1305 may be internal systems. Electronic transfer staging 1302 may be defined as a module configured for completing an electronic transfer, as described in step 611 of method 600. The PING Identity Access Management 1305 may be a module configured to perform token introspection, as defined in step 703 of method 700. The modules profile/repository verification service 1303, tokenization service 1304, and blockchain implemented directory 1406 may be software developer kit functionality. The module profile/repository verification service 1303 may be a computer application such as GIACT, or other similar application, as described in step 609 of method 600 and in step 704 of method 700. The blockchain implemented directory 1406 may be a first directory of internal profiles and external profiles or a second directory of external profiles implemented on a blockchain, where each directory entry may be an entry on the blockchain ledger. And the module electronic transfer directory service user application 1301 may be an external system/application. Electronic transfer directory service user application 1301 may be a computer application running on entity computing device 506, consistent with disclosed embodiments. An internal system may be a module that is created, performed, or executed internally within the software developer kit. An external system may be a module that needs to interact with, for example, an external software developer kit, or a user interface, to perform its function.

As shown in FIG. 13, in some embodiments, smart contracts may be used to automatically initiate payment instructions using a blockchain implemented directory 1306. Smart contracts are programs stored on a blockchain that run when predetermined conditions are met. Smart contracts may automate the execution of an agreement so that all participants maybe immediately certain of the outcome, without any intermediary's involvement or time loss. Smart contracts may automate a workflow by triggering the next action when conditions are met.

The disclosed embodiments are not limited to the above-described examples, but instead are defined by the appended claims in light of their full scope of equivalents. Moreover, while illustrative embodiments have been described herein, the scope includes any and all embodiments having equivalent elements, modifications, omissions, combinations (e.g., of aspects across various embodiments), adaptations, or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods maybe modified in any manner, including by reordering steps or inserting or deleting steps.

It is intended, therefore, that the specification and examples be considered as example only, with a true scope and spirit being indicated by the following claims and their full scope of equivalents.

1. A non-transitory computer readable medium containing instructions that when executed by at least one processor, cause the at least one processor to perform operations for verifying entities and provide an electronic transfer between entities, the operations comprising:
retrieving a first reference number and a first transmit number associated with a first entity repository, wherein the first entity repository is owned by a first entity;
generating a first internal profile associated with the first entity, wherein the first internal profile includes the first reference number and the first transmit number associated with the first entity repository;
generating a first access token, wherein the first access token includes a first identification;
generating a first external profile associated with the first entity, wherein the first external profile for the first entity includes the first access token;
storing the first internal profile and the first external profile in a first directory of profiles, wherein the first directory of profiles includes a plurality of internal profiles and a plurality of external profiles both associated with a plurality of entities;
retrieving a second identification of a second access token, wherein the second access token is associated with a second external profile from the plurality of external profiles;
identifying a second entity associated with the second external profile using the second identification;
identifying a second internal profile from the plurality of internal profiles associated with the second entity;
using a second reference number and a second transmit number associated with the second internal profile, identifying a current status and a history of a second entity repository associated with the second internal profile,
distributing the current status and the history associated with the second entity repository to the first entity; and
upon receiving a positive status indication and a positive history indication, generating data associated with an electronic transfer from the first entity repository to the second entity repository and providing the data associated with the electronic transfer to the second entity to initiate the electronic transfer from the first entity repository to the second entity repository.

2. The non-transitory computer readable medium of claim 1, the operations further comprising creating a second directory that includes external profiles.

3. The non-transitory computer readable medium of claim 2, the operations further comprising:
determining a frequency of electronic transfers associated with each external profile in the second directory;
automatically arranging the external profiles in a list based on the determined frequencies; and
displaying, on a graphical user interface, the list of arranged external profiles, wherein the list of arranged external profiles is displayed in descending order of the determined frequencies, from the external profile having a highest frequency to the external profile having a lowest frequency.

4. The non-transitory computer readable medium of claim 1,
wherein the history includes a positive history indication that is calculated by:
assigning weights to a first set of data points indicating a positive history;
calculating a weighted average of the first set of data points; and
determining whether the weighted average falls above a predetermined threshold.

5. The non-transitory computer readable medium of claim 1,
wherein the history includes a neutral history indication that is calculated by:
assigning weights to a second set of data points indicating a neutral history;
calculating a weighted average of the second set of data points; and
determining whether the weighted average falls within a predetermined range.

6. The non-transitory computer readable medium of claim 1,
wherein the history includes a negative history indication that is calculated by:
assigning weights to a third set of data points indicating a negative history;
calculating a weighted average of the third set of data points; and
determining whether the weighted average falls below a predetermined threshold.

7. The non-transitory computer readable medium of claim 1, wherein the current status includes verifying a standing of the second entity repository and an ownership of the second entity repository.

8. The non-transitory computer readable medium of claim 1, wherein one or more of the first access token and the second access token have an expiration time.

9. The non-transitory computer readable medium of claim 1, wherein the distributing includes displaying the current status and the history on a graphical user interface of the first entity.

10. The non-transitory computer readable medium of claim 1, wherein the instructions are stored as an individual application programming interface or a software developer kit.

11. A method for verifying entities and providing an electronic transfer between entities, the method comprising:
retrieving a first reference number and a first transmit number associated with a first entity repository, wherein the first entity repository is owned by a first entity;
generating a first internal profile associated with the first entity, wherein the first internal profile includes the first reference number and the first transmit number associated with the first entity repository;
generating a first access token, wherein the first access token includes a first identification;
generating a first external profile associated with the first entity, wherein the first external profile for the first entity includes the first access token;
storing the first internal profile and the first external profile in a first directory of profiles, wherein the first directory of profiles includes a plurality of internal profiles and a plurality of external profiles both associated with a plurality of entities;
retrieving a second identification of a second access token, wherein the second access token is associated with a second external profile from the plurality of external profiles;
identifying a second entity associated with the second external profile using the second identification;
identifying a second internal profile from the plurality of internal profiles associated with the second entity;
using a second reference number and a second transmit number associated with the second internal profile, identifying a current status and a history of a second entity repository associated with the second internal profile,
distributing the current status and the history associated with the second entity repository to the first entity; and
upon receiving a positive status indication and a positive history indication, generating data associated with an electronic transfer from the first entity repository to the second entity repository and providing the data associated with the electronic transfer to the second entity to initiate the electronic transfer from the first entity repository to the second entity repository.

12. A system for verifying entities and providing an electronic transfer between entities, the system comprising:
at least one processor configured to:
retrieve a first number and a first transmit number associated with a first entity repository, wherein the first entity repository is owned by a first entity;
generate a first internal profile associated with the first entity, wherein the first internal profile includes the first reference number and the first transmit number associated with the first entity repository;
generate a first access token, wherein the first access token includes a first identification;
generate a first external profile associated with the first entity, wherein the first external profile for the first entity includes the first access token;
store the first internal profile and the first external profile in a first directory of profiles, wherein the first directory of profiles includes a plurality of internal profiles and a plurality of external profiles both associated with a plurality of entities;
retrieve a second identification of a second access token, wherein the second access token is associated with a second external profile from the plurality of external profiles;
identify a second entity associated with the second external profile using the second identification;
identify a second internal profile from the plurality of internal profiles associated with the second entity;
using a second reference number and a second transmit number associated with the second internal profile, identify a current status and a history of a second entity repository associated with the second internal profile,
distribute the current status and the history associated with the second entity repository to the first entity; and
upon receiving a positive status indication and a positive history indication, generate an electronic transfer from the first entity repository to the second entity repository.

13. The method of claim 11, the method further comprising creating a second directory that includes external profiles.

14. The method of claim 11, wherein one or more of the first access token and the second access token have an expiration time.

15. The method of claim 11, wherein the current status includes verifying a standing of the second entity repository and an ownership of the second entity repository.

16. The method of claim 11, wherein the distributing includes displaying the current status and the history on a graphical user interface of the first entity.

17. The system of claim 12, wherein the processor is further configured to create a second directory that includes external profiles.

18. The system of claim 12, wherein one or more of the first access token and the second access token have an expiration time.

19. The system of claim 12, wherein the current status includes verifying a standing of the second entity repository and an ownership of the second entity repository.

20. The system of claim 12, wherein the distributing includes displaying the current status and the history on a graphical user interface of the first entity.
